(19) United States
(12) Patent Application Publication
(10) Pub. No.: US 2026/0105652 A1
(43) Pub. Date: Apr. 16, 2026

(54) DECOMPOSING FILLED PATH TEXT OR DESIGNS TO STROKE-BASED TEXT OR DESIGNS

(71) Applicant: Adobe Inc., San Jose, CA (US)

(72) Inventors: Garv Tandon, Greater Noida (IN); Praveen Kumar Dhanuka, Howrah (IN); Arushi Jain, Delhi (IN)

(21) Appl. No.: 18/911,829

(22) Filed: Oct. 10, 2024

(51) Int. Cl. G06T 11/20

(52) U.S. Cl. CPC G06T 11/23

(57) ABSTRACT

The present disclosure is directed toward systems, methods, and non-transitory computer readable media that use a multistep process to convert a vector-based outline shape to a stroke based design. In particular, the disclosed systems generate an undirected graph encoding the medial axis of a vector-based outline shape with a continuous sequence of edges connected by vertices. Furthermore, the disclosed systems prune external branches of the medial axis outside a boundary of the vector-based outline shape. In addition, the disclosed systems prune non-salient branches of the medial axis by removing branches corresponding to minor protrusions or sharp corners of the vector-based outline shape. Moreover, the disclosed systems perform transitions to adjust the branches of the undirected graph based on maximal disks centered on vertices of the undirected graph.

### BACKGROUND

Advancements in computing devices and computer design applications have led to innovative developments in computer image design and editing software. For example, certain computer design applications enable the editing and manipulation of digital images including vector-based shapes to generate a diverse range of digital designs. Existing workflows allow for transitioning from strokes representing stroke-based designs to filled vector paths. However, despite these advances, current vector-based applications are limited in their ability interpret the complexities of filled vector paths to recover the strokes for stroke-based designs (e.g., font glyphs or vector art). As a result, decomposing stroke-based designs remains a tedious procedure that often requires complex font personalization and/or stroke recovery. Consequently, existing image editing systems have a number of shortcomings with regard to flexibility, efficiency, and accuracy when extracting strokes from font glyphs and or vector art.

### SUMMARY

One or more embodiments provide benefits and/or solve one or more of the foregoing or other problems in the art with systems, methods, and non-transitory computer readable storage media that extract strokes from filled stroke-based designs. For example, the disclosed systems use a multistep process to extract a medial axis of a vector-based outline shape, refine the medial axis to accurately reflect the vector-based outline shape, and generate strokes representing the structure of the vector-based outline shape. In particular, the disclosed systems generate an undirected graph encoding the medial axis of a vector-based outline shape with a continuous sequence of edges connected by vertices that capture the structure of the vector-based outline shape. Furthermore, the disclosed systems prune external branches of the medial axis outside a boundary of the vector-based outline shape. In addition, the disclosed systems prune non-salient branches of the medial axis by removing branches corresponding to minor protrusions or sharp corners of the vector-based outline shape. Utilizing the structure of the refined medial axis, the disclosed systems generate a stroke graph and decompose the vector-based outline shape into strokes. For example, utilizing the stroke graph, the disclosed systems apply various transitions to merge and/or refine branches of the undirected graph based on maximal disks centered on vertices of the medial axis.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a stroke extraction system in accordance with one or more embodiments;

FIG. 2 illustrates an example overview of utilizing an undirected graph to encode a medial axis and convert a vector-based outline shape to strokes in accordance with one or more embodiments;

FIG. 3 illustrates an example of utilizing a Voronoi-based approximation technique to generate a medial axis for a vector-based outline shape in accordance with one or more embodiments;

FIGS. 4A-4C illustrate an example of generating and utilizing an undirected graph to encode a medial axis in accordance with one or more embodiments;

FIGS. 5A-5C illustrate an example of pruning the external and non-salient branches from the medial axis in accordance with one or more embodiments;

FIG. 6 illustrates an example of merging and refining branches of the medial axis at a vertex in accordance with one or more embodiments;

FIGS. 7A-7B illustrate converting a medial axis into a stroke graph to capture the structure and properties of the vector-based outline shape using strokes in accordance with one or more embodiments;

FIG. 8 illustrates the stroke extraction system performing transitions for the branches connecting to a vertex at a T-junction in accordance with one or more embodiments;

FIG. 9 illustrates the stroke extraction system performing transitions for the branches connecting to a vertex at a Y-junction in accordance with one or more embodiments;

FIG. 10 illustrates the stroke extraction system performing transitions for the branches connecting to a vertex at a L-junction in accordance with one or more embodiments;

FIG. 11 illustrates the stroke extraction system performing transitions for the branches connecting to a vertex at a terminal junction in accordance with one or more embodiments;

FIG. 12 illustrates the stroke extraction system performing transitions for a crossing junction where two or more fork disks overlap in accordance with one or more embodiments;

FIG. 13 illustrates a diagram of an example architecture of the stroke extraction system in accordance with one or more embodiments;

FIG. 14 illustrates a flowchart of a series of acts for extracting strokes from a vector based-outline shape in accordance with one or more embodiments; and

FIG. 15 illustrates a block diagram of an example computing device in accordance with one or more embodiments.

### DETAILED DESCRIPTION

This disclosure describes one or more embodiments of a stroke extraction system extracts a latent stroke structure from vector-outline based designs (e.g., font glyphs or vector art) using a multistep approach that includes extracting a medial axis, discarding excess medial axis branches, and refining medial axis branches at junctions. As part of the multistep approach, in one or more embodiments, the stroke extraction system generates an undirected graph encoding the medial axis of a vector-based outline shape with a continuous sequence of edges connected by vertices that capture the structure of the vector-based outline shape. Furthermore, in some cases, the stroke extraction system prunes external branches of the medial axis outside a boundary of the vector-based outline shape. In addition, in some cases, the stroke extraction system prunes non-salient branches of the medial axis by removing branches corresponding to minor protrusions or sharp corners of the vector-based outline shape. Based on the refined medial axis, in certain embodiments, the stroke extraction system utilizes a stroke graph to apply various transitions to merge and/or refine branches of the undirected graph at junctions utilizing maximal disks centered on vertices of the medial axis. In this way, in one or more embodiments, the stroke extraction system utilizes the stroke graph to decompose the vector-based outline shape into strokes.

More specifically, in one or more embodiments, the stroke extraction system extracts a medial axis from a vector-based outline shape. For example, the stroke extraction system utilizes a Voronoi-based approximation technique to generate a medial axis for the vector-based outline shape. In one or more embodiments, the stroke extraction system generates an undirected graph corresponding to the structure of the vector-based outline shape by connecting points (using branches and junctions) that are equidistant from the boundary of the vector-based outline shape. For example, the stroke extraction system constructs an undirected planar graph by encoding the medial axis constructed from the edges connected at the Voronoi vertices.

In certain embodiments, the stroke extraction system utilizes an adjacency list implementation process to construct the medial axis, where each edge and vertex encode information about the structure of the medial axis. For instance, the stroke extraction system utilizes a Delaunay triangulation graph corresponding to the Voronoi representation, with Delaunay edges indicating the adjacency of the Voronoi regions. In some cases, each Voronoi vertex (e.g., a point where three or more Voronoi cells converge) corresponds to a Delaunay face (e.g., a triangle in the Delaunay triangulation). Conversely, each Delaunay vertex corresponds to a Voronoi region.

In certain embodiments, the stroke extraction system prunes external branches and non-salient branches from the medial axis to generate the undirected graph representing the vector-based shape. For example, the stroke extraction system determines or isolates the internal medial axis by removing branches that are located outside of the vector-based outline (e.g., external branches). In some cases, the stroke extraction system refines the internal medial axis by discarding spurious branches (e.g., branches corresponding to discretization error of the Voronoi-based process).

Additionally, in some cases, the stroke extraction system removes non-salient branches while retaining the salient branches. For example, the stroke extraction system removes non-salient branches at stroke ends, corners, and elbows (e.g., representing minor protrusions or sharp corners). In some cases, the stroke extraction system removes non-salient branches that are unnecessary to represent the vector-based shape structure. In this way, in one or more embodiments, the stroke extraction system removes branches that are visually redundant or structurally superfluous for stroke reconstruction to provide a precise stroke depiction of the vector-based outline shape with fewer strokes.

In some cases, the stroke extraction system merges branches of the medial axis located at vertices based on the structure of the vector-based outline shape. In one or more embodiments, the stroke extraction system utilizes a stroke graph to merge and refine the branches at junctions to mimic hand tracing of the vector-based shape. For example, by analyzing vertices of the medial axis, the stroke extraction system can determine the stroke decomposition of the vector-based shape. After the stroke extraction system performs merging and deletion operations, each connected component of the stroke graph represents one particular stroke in the final stroke design. In this way, the stroke extraction system merges the branches of the medial axis to provide simple, coherent strokes that visually represent the vector-based shape in a way that makes sense visually.

To elaborate, in one or more embodiments, the stroke extraction system performs transitions at the vertices of the undirected graph utilizing straight transitions and/or a smoothing transitions based on the junction type. In one or more embodiments, the stroke extraction system prunes, from the undirected graph (e.g., the medial axis), non-salient branches which are connected at vertices and do not satisfy a saliency threshold when determining the junction type. Furthermore, in certain embodiments, the stroke extraction system determines the junction type of the vertex by comparing the tangents of the branches connected to the vertex.

In certain embodiments, the stroke extraction system performs smoothing transitions and/or straight transitions at the vertices of the medial axis based on the junction types. For example, the stroke extraction system uses a smoothing transition to merge two stroke segments into a composite stroke segment at the junction. In some cases, the stroke extraction system uses a smoothing transition to correct a distortion in a branch of the medial axis at the junction. In some cases, the stroke extraction system uses a straight transition to extend/shorten a stroke segment at the junction. In some embodiments, the stroke extraction system performs smoothing transitions and/or straight transitions based on junction types including T-junctions, Y-junctions, L-junctions, crossing junctions, and terminal junctions.

As described above, the stroke extraction system overcomes shortcomings inherent in conventional systems that provide tools for stroke recovery. Specifically, conventional systems have a number of technical shortcomings with regard to flexibility, accuracy, and operational efficiency when reconstructing fonts using strokes. For example, many existing design systems lack the flexibility and capability to accurately reconstruct the latent stroke structure from filled vector-based designs.

While some existing design systems provide tools that enable the conversion of strokes into filled vector paths, these tools are often unidirectional. In many existing design systems, once a stroke has been converted into a filled vector path, there is no straightforward method to reverse the process and convert the filled vector path back into strokes representing the latent stroke structure of the filled vector path. Because modern fonts are predominantly represented as vector-based outlines, the unidirectional approach of current design systems poses significant challenges when manipulating and customizing fonts within vector designs. In particular, the rigidity of these existing design systems limits the ability of the systems to manipulate and customize fonts and vector artwork based on their underlying stroke structures.

In addition, some existing design systems are constrained by their inability to account for the nuanced variations of different font styles. For example, while some exiting design systems perform font stylization on glyph outlines, these existing design systems often rely on pre-defined structures which are generated for each input glyph. For example, these existing design systems use a skinning approach to assign a predefined structure to a font glyph and transform the input glyph into parametric strokes. These existing design systems then propagate changes made to one glyph to newly generated glyphs within the entire font. However, this method of transferring a style from one glyph to an entire font is often rigid, failing to accommodate for the subtle variations within a font.

In addition to inflexibility, existing design systems are inaccurate when dealing with diverse typographic styles of Western fonts. For example, East Asian characters, which often adhere to a hierarchical structure of radicals and strokes, are typically decomposed using large datasets and data-driven methods. While these methods of existing design systems may work for East Asian characters, they frequently fail when applied to Western fonts. In particular, Western glyphs, which exhibit a broader range of stylistic variations and decorative elements, often involve an intricate blending of components, making accurate segmentation and stroke representation difficult. Some existing systems have attempted to mitigate the challenges of converting Western glyphs by training neural networks to synthesize strokes from bitmap images of handwriting, guided by calligraphy experts. However, these methods depend on automatic segmentation processes that often do not reliably reconstruct strokes from the font glyphs, leading to inaccuracies in the generated strokes.

Relatedly, many existing design systems are operationally inefficient. In some cases, existing design systems place a significant reliance on manual input. For example, some existing design systems rely on user-guided segmentation or skeleton alignment for the font glyph. To illustrate, with many existing design systems, users must manually select, trace, and correct a user-defined structure generating and interacting with many points, which is resource-consuming and labor-intensive. Furthermore, existing design systems that utilize neural networks to generate strokes from font glyphs require the generation of extensive datasets to train the neural networks for diverse font types, adding another layer of complexity and inefficiency. Additionally, some existing systems generate strokes from font glyphs using complex procedures that require an analysis of curvilinear shape features to generate stroke decompositions from font glyphs. For example, these systems analyze the concavities and convexities within vector shapes, a procedure that can prove cumbersome and computationally expensive.

As suggested above, embodiments of the stroke extraction system provide a variety of advantages of conventional design systems. For example, one or more embodiments of the stroke extraction system improve flexibility over existing design systems by generating plausible stroke-based segmentations of glyphs using shape analysis alone. In this way, embodiments of the stroke extraction system have the considerable advantage of being agnostic to the specific symbols or glyphs or vector art, working with stroke-based designs that do not match any standard letter structure. Unlike existing design systems that rely on training data or templates, the stroke extraction system functions effectively across a wide variety of non-standard character structures, diverse typographic styles, and/or stroke-based designs. In particular, unlike existing design systems, the stroke extraction system utilizes a versatile stroke decomposition method that can apply to an entire font. Notably, embodiments of the stroke extraction system can be applied to other 2D shapes (and not just font glyphs) that can be closely approximated by a series of strokes, extending the utility of the stroke extraction system beyond traditional typography.

Relatedly, the stroke extraction system provides advantages in accuracy over existing design systems. For example, unlike existing systems that rely on extensive datasets to convert fonts into strokes, the stroke extraction system avoids the need for data-driven analysis, reducing the risk of inaccuracies in stroke recovery due to unexpected variations in fonts. Similarly, the stroke extraction system does not require prior tracing of the font glyphs, accurately reconstructing the latent stroke structure of any vector art without requiring prior tracing or the use of pre-defined structures. By leveraging the topological properties of vector shapes using the medial axis, the stroke extraction system ensures accurate stroke recovery that reflects the true structure of the input vector-based shape.

Furthermore, the stroke extraction system provides computational efficiency over existing design systems. For example, unlike existing design systems, the stroke extraction system does not require extensive training data or templates, thereby improving computational efficiency and resource consumption. Instead, the stroke extraction system efficiently generates strokes directly from the medial axis, reducing the computational overhead associated with more complex stroke recovery methods. Additionally, unlike systems that require a complex analysis of the concavities and convexities within vector shapes, the stroke extraction system generates realistic stroke compositions using only the medial axis of the vector-based shape in a more computationally efficient method.

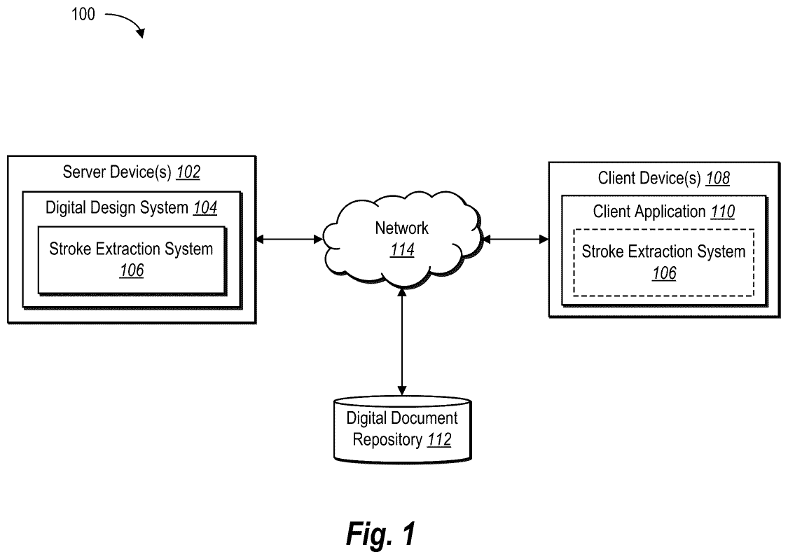

Additional detail regarding the stroke extraction system will now be provided with reference to the figures. For example, FIG. 1 illustrates a schematic diagram of an exemplary system environment (“environment”) 100 in which a stroke extraction system 106 operates. As illustrated in FIG. 1, the environment 100 includes server device(s) 102, a network 114, and client device(s) 108.

Although the environment 100 of FIG. 1 is depicted as having a particular number of components, the environment 100 is capable of having any number of additional or alternative components (e.g., any number of servers, client devices, or other components in communication with the stroke extraction system 106 via the network 114. Similarly, although FIG. 1 illustrates a particular arrangement of the server device(s) 102, the network 114, and client device(s) 108, various additional arrangements are possible.

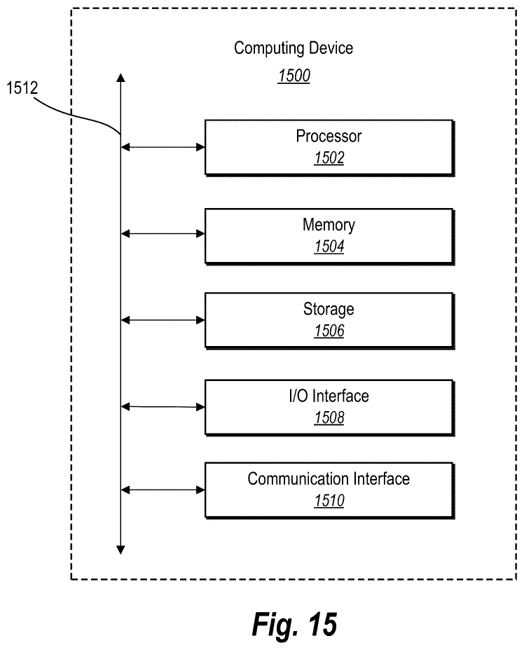

The server device(s) 102, the network 114, and client device(s) 108 are communicatively coupled with each other either directly or indirectly (e.g., through the network 114 discussed in greater detail below in relation to FIG. 15). Moreover, the server device(s) 102 and client device(s) 108 include one of a variety of computing devices (including one or more computing devices as discussed in greater detail with relation to FIG. 15).

As illustrated in FIG. 1, the environment 100 includes the server device(s) 102 and digital design system 104. The server device(s) 102 utilizes the digital design system 104 to generate, track, store, process, receive, and transmit electronic data including stroke-based designs. For example, the server device(s) 102 receives or monitors interactions across the client device(s) 108. In some embodiments, the server device(s) 102 transmits content to the client device(s) 108 to cause the client device(s) 108 to display content associated with decomposing stroke-based designs into strokes. For example, the server device(s) 102 presents stroke-based designs to client device(s) 108 and displays stroke-based designs on the client device(s) 108 with the stroke-based designs displayed corresponding to system need (e.g., provide stroke-based designs, filled vector paths, and strokes for display via the client application 110). The server device(s) 102 further access and utilize the digital document repository 112 to store and retrieve information such as stored digital documents, digital images, vector content, stroke-based designs, strokes, and/or other data.

Additionally, the server device(s) 102 includes all, or a portion of, the stroke extraction system 106. For example, the stroke extraction system 106 operates on the server device(s) 102 to access digital content (including images and vector outlines), determine digital content changes, and provide localization of content changes to the client device(s) 108. In one or more embodiments, via the server device(s) 102, the stroke extraction system 106 generates and displays stroke-based designs, filled vector paths, and/or strokes based on the client device(s) 108 input. Example components of the stroke extraction system 106 will be described below with regard to FIG. 15.

Furthermore, as shown in FIG. 1, the illustrated system includes the client device(s) 108. In some embodiments, the client device(s) 108 include, but are not limited to, mobile devices (e.g., smartphones, tablets), laptop computers, desktop computers, or another type of computing devices, including those explained below in reference to FIG. 15. Some embodiments of client device(s) 108 are operated by a user to perform a variety of functions via client application 110 such as the generation of strokes for stroke-based designs. The client device(s) 108 include one or more applications (e.g., the client application 110) that access, edit, modify, store, and/or provide, for display, digital image content. For example, in some embodiments, the client application 110 include a software application installed on the client device(s) 108. In other cases, however, the client application 110 include a web browser or other application that accesses a software application hosted on the server device(s) 102.

In one or more embodiments, the stroke extraction system 106 is implemented in whole, or in part, by the individual elements of the environment 100. Indeed, as shown in FIG. 1, the stroke extraction system 106 is implemented with regard to the server device(s) 102 and the client device(s) 108. In particular embodiments, the stroke extraction system 106 on the client device(s) 108 comprises a web application, a native application installed on the client device(s) 108 (e.g., a mobile application, a desktop application, a plug-in application, etc.), or a cloud-based application where part of the functionality is performed by the server device(s) 102.

In additional or alternative embodiments, the stroke extraction system 106 on the client device(s) 108 represents and/or provides the same or similar functionality as described herein in connection with the stroke extraction system 106 on the server device(s) 102. In some embodiments, the stroke extraction system 106 on the server device(s) 102 supports the stroke extraction system 106 on the client device(s) 108.

In some embodiments, the stroke extraction system 106 includes a web hosting application that allows the client device(s) 108 to interact with content and services hosted on the server device(s) 102. To illustrate, in one or more embodiments, the client device(s) 108 accesses a web page or computing application supported by the server device(s) 102. The client device(s) 108 provides input to the server device(s) 102 (e.g., selected vector content). In response, the stroke extraction system 106 on the server device(s) 102 deconstructs vector content into strokes. The server device(s) 102 then provides the strokes to the client device(s) 108.

In some embodiments, though not illustrated in FIG. 1, the environment 100 has a different arrangement of components and/or has a different number or set of components altogether. For example, in certain embodiments, the client device(s) 108 communicate directly with the server device(s) 102, bypassing the network 114. As another example, the environment 100 includes a third-party server comprising a content server and/or a data collection server.

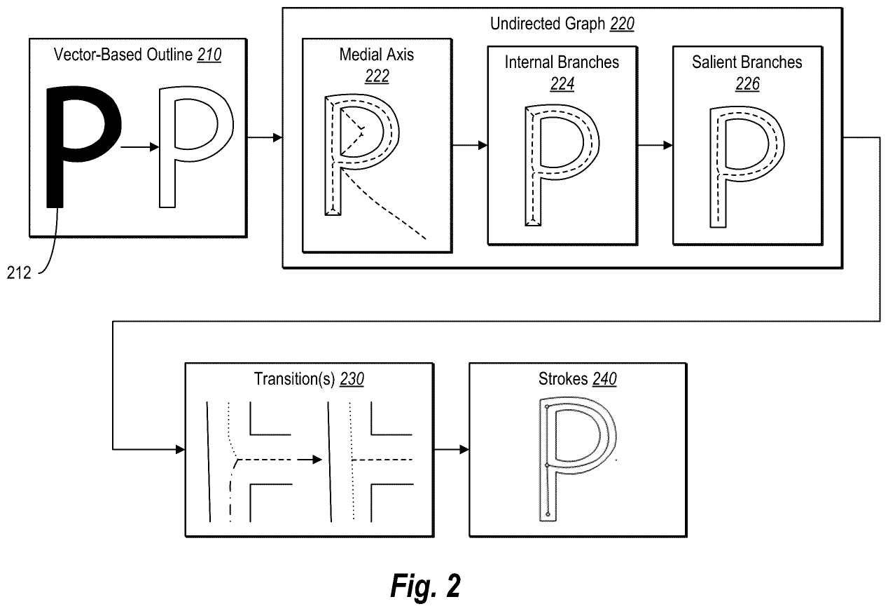

As previously mentioned, in one or more embodiments, the stroke extraction system 106 decomposes strokes from filled vector paths. For instance, FIG. 2 illustrates an example overview of utilizing an undirected graph to encode a medial axis and convert a vector-based outline shape to strokes in accordance with one or more embodiments. Additional detail regarding the various acts of FIG. 2 is provided thereafter with reference to subsequent figures.

As shown in FIG. 2, the stroke extraction system 106 receives or determines a vector-based outline 210. For example, the vector-based outline 210 includes or refers to a vector-based outline shape that includes the outer edges or boundaries of a vector object. In some embodiments, the vector-based outline 210 represents or outlines the shape of a vector object including straight lines and curves (e.g., Bézier curves). In some cases, the vector-based outline 210 includes the outline excluding the interior fill. As shown, the vector-based outline 210 includes an outline representing textual content such as scalable, editable textual characters or font glyphs. In some cases, the vector-based outline 210 includes an outline representing the articulated structure of a stroke-based design that is not a font glyph.

In some cases, the stroke extraction system 106 determines the vector-based outline 210 from a filled vector outline 212. For example, the stroke extraction system 106 receives a filled vector outline 212 including or referring to a vector outline of textual content filled with color, gradient, pattern, or other effects that occupy the interior space of the vector object. In some cases, the stroke extraction system 106 receives or determines the filled vector outline 212 as a solid shape that includes an outer edge and a filled interior.

As further shown, the stroke extraction system 106 generates, from the vector-based outline 210, an undirected graph encoding a medial axis corresponding to features of the vector-based outline shape. For example, the undirected graph 220 includes a representation of a medial axis 222, wherein the medial axis 222 includes or refers to a set of points equidistant from the boundaries of the vector-based outline 210. In some cases, the undirected graph 220 represents the medial axis 222 utilizing vertices (e.g., junctions/forks and terminals) and edges connecting the vertices (e.g., paths along the medial axis). For example, the stroke extraction system 106 generates the undirected graph 220 by encoding a medial axis 222 with branches corresponding to continuous sequences of edges connected at vertices. In some cases, the stroke extraction system 106 generates the medial axis 222 utilizing a discrete Voronoi-based approximation. For example, the stroke extraction system 106 utilizes a Voronoi approximation to define a set of points corresponding to centers of maximal disks, wherein the maximal disks have more than one closest point on the boundary of the vector-based outline shape.

In addition, the stroke extraction system 106 retains the internal branches 224 of the medial axis 222 to generate the undirected graph 220. In some cases, the stroke extraction system 106 prunes external branches positioned outside the boundary of the vector-based outline 210 to retain the internal branches 224.

As shown, in one or more embodiments, the stroke extraction system 106 determines the salient branches 226 to refine the medial axis for the vector-based outline 210. For example, the salient branches 226 include or refer to branches of the medial axis 222 that represent the most significant features of the vector-based outline 210. To illustrate, the stroke extraction system 106 utilizes the salient branches 226 to reduce the complexity of representation of the medial axis 222.

In some cases, the stroke extraction system 106 prunes non-salient branches by removing branches that exceed a saliency threshold. For example, the stroke extraction system 106 determines salient branches 226 based on the length and positioning of branches connecting vertices of the medial axis 222. In certain embodiments, the stroke extraction system 106 determines the salient branches 226 by comparing the length of an outline segment relative to its width at a vertex where the branch is connected within the vector-based outline to determine a branch saliency. In this way, the stroke extraction system 106 removes non-salient branches that are part of the medial axis and do not contribute significantly to the overall structure of the vector-based outline 210.

As further shown in FIG. 2, the stroke extraction system 106 adjusts branches of the undirected graph 220 by performing transition(s) 230 at vertices. For example, the stroke extraction system 106 merges and/or refines the branches of the medial axis at vertices and/or terminals. To elaborate, the stroke extraction system 106 determines the branches of the medial axis associated a vertex. In addition, the stroke extraction system 106 compares the tangents for the branches associated with the vertex. For example, the stroke extraction system 106 compares the tangents of the branches at the locations of the intersections of the branches with a maximal disk centered on the vertex. Based on the determined tangents, the stroke extraction system 106 adjusts the branches utilizing straight transitions and/or smoothing transitions for the transition(s) 230.

In some embodiments, the stroke extraction system 106 utilizes a stroke graph to perform the transition(s) 230. In one or more embodiments, a stroke graph includes or refers to a tool used to transform the branches of the undirected graph 220 into strokes. In some embodiments, a stroke graph associates each branch of the medial axis with a vertex in the stroke graph, incorporates stroke spines corresponding to the central path of the strokes (e.g., tracing a route of the branch from the medial axis representing the general direction and shape of the stroke), and incorporates a stroke width determined by the radii of the medial axis disks at each point along the branch. To illustrate, for each branch of the medial axis, the stroke extraction system 106 determines an associated vertex in the stroke graph. In addition, the stroke extraction system 106 merges two branches by adding an edge between corresponding vertices of the stroke graph. In some cases, the stroke extraction system 106 deletes non-salient branches by discarding the associated vertices from the stroke graph. As a result of performing the transition(s) 230 utilizing the stroke graph, the stroke extraction system 106 converts the vector-based outline 210 into a stroke-based design incorporating the strokes 240.

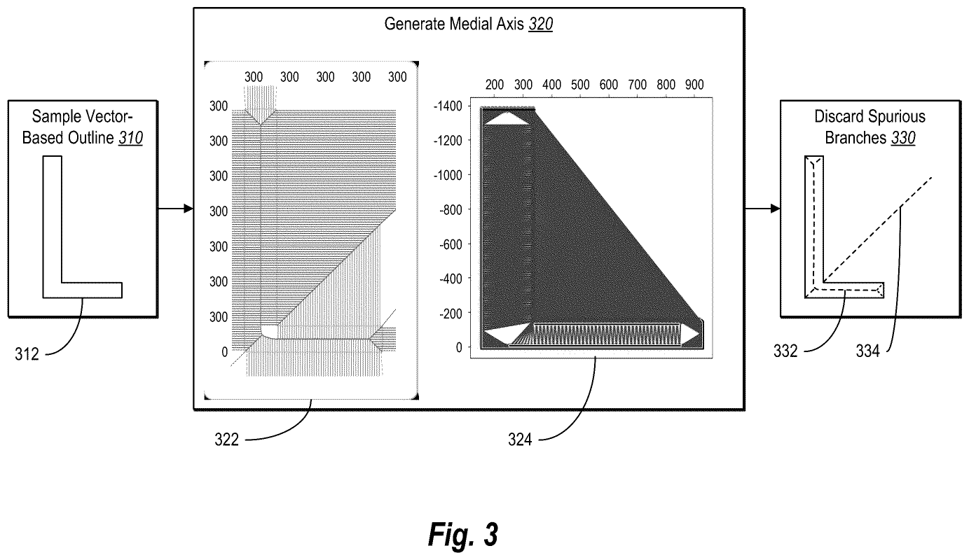

As mentioned, the stroke extraction system 106 generates the medial axis from a vector-based outline shape. FIG. 3 illustrates an example of utilizing a Voronoi-based approximation technique to generate a medial axis for a vector-based outline shape in accordance with one or more embodiments. In some cases, the stroke extraction system 106 constructs an undirected planar graph encoding the medial axis from edges connected at the Voronoi vertices. Furthermore, the stroke extraction system 106 utilizes an adjacency list implementation process wherein each edge and vertex encode information about the medial axis (e.g., defining a Delaunay edge reflecting the adjacency of the Voronoi regions).

In one or more embodiments, the stroke extraction system 106 performs an act 310 to densely sample the vector-based outline shape 312. For example, the stroke extraction system 106 samples the vector-based outline shape 312 by scaling the vector-based outline shape 312, sampling the vector-based outline shape 312, and rescaling the vector-based outline shape 312. To illustrate, in one or more embodiments, the stroke extraction system 106 scales the vector-based outline shape 312 to a height of 150 units and samples the vector-based outline shape 312 at 1 unit distance. The stroke extraction system 106 scales the vector-based outline shape 312 back to the input height and calculates the average length of chords joining the sampled points. For example, in some embodiments, the stroke extraction system 106 performs the act 310 to sample the vector-based outline shape 312 utilizing the following algorithm:

Vector-based Outline Sampling Logic Algorithm:

```
Begin by finding all svg files in specified input directory. For each item (.svg file name)
specified, perform the sampling (union = True, shape_size = 150 destination).
1. Important function → load_svg
  i. Svg_to_beziers
    a. Svg to paths
    b. Split compound paths into separate paths
    c. Svg paths to Bézier control points
  ii. Sample a piecewise Bézier curve given a sequence of control points″′ for each
path (40 fixed samples for each Bézier segment) (e.g., iterate through 3 consecutive control
points for 3 degree Bézier probability)
2. Clipper functions (If union is True, in current working example it is True)
  i. Offset by 5 units
  ii. Take union with itself
  iii. Offset by −5 units
3. Rescale to 150 height and calculate ratio with respect to original height (Rescaling −
Point * ratio for all points)
4. Sample at uniform distance of 1 unit along each contour
  ∘ Idea is to interpolate between points at fixed interval points
  ∘ Points to note−> Sampling is done in domain of 150 height and is done at a
distance of 1 unit
5. Fix shape winding (clockwise or counterclockwise)
  i. If all desired is clockwise change all to clockwise. Except for hole curves.
6. Scale sampled shape back to original height
```

In one or more embodiments, the stroke extraction system 106 generates a medial axis by generating, utilizing a Voronoi diagram 322, edges comprising sets of points equidistant from the boundary of a vector-based outline shape 312. For example, the stroke extraction system 106 adds vertices to the undirected graph for each vertex obtained from the Voronoi diagram. Furthermore, in some cases, the stroke extraction system 106 adds graph edges for each edge obtained from the Voronoi diagram and associates each edge with the anchor points for the edge. In some embodiments, the stroke extraction system 106 stores the anchor points as a reference for the associated maximal disks associated with the medial axis.

For example, as shown in FIG. 3, the stroke extraction system 106 performs an act 320 to construct the Voronoi diagram 322 for the points sampled from the vector-based outline shape 312. For example, to construct the Voronoi diagram 322, the stroke extraction system 106 determines a set S of n points in the 2D plane corresponding to the points sampled from the vector-based outline shape 312 as described above. In some cases, the stroke extraction system 106 generates the Voronoi diagram 322 as a partition of the 2D plane into regions. In particular, the region associated with a point p∈S contains precisely the points q such that q is closer to p than any other point in S. In other words, a point q belongs to the region of its nearest neighbor.

As further shown, the stroke extraction system 106 utilizes a Delaunay triangulation graph 324 in conjunction with the Voronoi diagram 322. For example, the stroke extraction system 106 generates the Delaunay triangulation graph 324 corresponding to the Voronoi diagram 322. In particular, the stroke extraction system 106 computes the Delaunay triangulation graph 324 for the set S as a triangulation (e.g., division of the 2D plane into triangles) where no point in S is inside the circumcircle of any triangle. For example, each Voronoi vertex (e.g., a point where three or more Voronoi cells meet) corresponds to a Delaunay face (e.g., a triangle in the Delaunay triangulation graph 324). Conversely, each Delaunay vertex (e.g., a point in S) corresponds to a Voronoi region (e.g., the cell in the Voronoi diagram 322 associated with that point). Furthermore, an edge in the Delaunay triangulation graph 324 connects two points p₁ and p₂ from S if and only if their corresponding Voronoi cells share a common boundary (e.g., a Delaunay edge reflects the adjacency of Voronoi regions). Additionally, the circumcenter of a Delaunay triangle (e.g., the center of the circle passing through all three vertices of the triangle) coincides with the position of the corresponding Voronoi vertex in the Voronoi diagram 322.

In one or more embodiments, the stroke extraction system 106 performs an act 330 to discard spurious branches and account for anomalies introduced by transitioning from a vector-based outline shape 312 to a set of discrete points. As shown in FIG. 3, these anomalies, in one or more instances, produce spurious (e.g., unwanted) branches on the medial axis of the Voronoi diagram 322. For example, the stroke extraction system 106 utilizes a regularization process to remove the spurious branches from the medial axis, which arise due to the discretization error. Additionally, the stroke extraction system deletes vertices of the medial axis that are not connected by branches (e.g., branches removed during the regularization process).

For example, the stroke extraction system 106 discards each Voronoi edge that is below a Voronoi threshold value to determine a medial axis which includes an internal medial axis 332 and an external medial axis 334 for the vector-based outline shape 312. For example, stroke extraction system 106 determines the internal medial axis 332 which includes or refers to the set of all points inside the vector-based outline shape 312 that have more than one closest point on the boundary of the vector-based outline shape 312. The internal medial axis 332 includes the points internal to the vector-based outline shape 312 and equidistant from the nearest boundary of the vector-based outline shape 312. Relatedly, in one or more embodiments, the external medial axis 334 includes or refers to points outside the boundary of the vector-based outline shape 312 that are equidistant to multiple points on the vector-based outline shape 312.

In one or more embodiments, the stroke extraction system 106 discards the spurious branches to determine the internal medial axis 332 and the external medial axis 334 utilizing an algorithm such as the following:

Chord Residual Regularization Algorithm

| | |
|---|---|
| 1. | procedure COMPUTERBOUNDARYPOTENTIAL(boundary) |
| 2. | origin ← boundary[0] |
| 3. | currentLength ← 0 |
| 4. | W ← { } |
| 5. | W[origin] ← 0 |
| 6. | |
| 7. | for i from 1 to length(boundary) − 1 do |
| 8. | distance + DISTANCE(boundary[i−1], boundary[i]) |
| 9. | currentLength += distance |
| 10. | W[boundary[i]] ← currentLength |
| 11. | |
| 12. | return W |
| 13. | |
| 14. | procedure COMPUTECHORDRESIDUAL(PA, PB, boundary, W) |
| 15. | Rp ← COMPUTECHORDRESIDUAL(PA, PB, boundary, W) |
| 16. | s ← DISTANCE(PA, PB) |
| 17. | Rh ← Rp − s |
| 18. | return Rh |
| 19. | |
| 20. | procedure COMPUTEPOTENTIALRESIDUAL (PA, PB, boundary, W) |
| 21. | if AREDISJOINTSEGMENTS(PA, PB, boundary) then |
| 22. | return INFINITY |
| 23. | w1 ← abs(W(PA) − W(PB)) |
| 24. | LB ← TOTALLENGTH(boundary) |
| 25. | w2 ← LB − abs(W(PA) − W(PB)) |
| 26. | distB ← min(w1, w2) |
| 27. | return distB |

As mentioned, the stroke extraction system 106 discards a Voronoi edge if the Voronoi edge length does not exceed the Voronoi threshold value. In one or more embodiments, the stroke extraction system 106 utilizes the property that each Voronoi edge of the Voronoi diagram 322 represents the local symmetry axis of exactly two boundary point sites (e.g., the anchor points of the edge). For example, the stroke extraction system 106 takes each edge of the Voronoi diagram 322 and computes the difference between the length along the outline and the length of the direct line (e.g., chord) connecting the anchor points corresponding to the Voronoi edge. In some embodiments, the stroke extraction system 106 utilizes a Voronoi threshold value of 0.03×ds (where ds is the average chord length as calculated by the “Vector-based Outline Sampling Logic Algorithm” described above in relation to the vector-based outline shape 312).

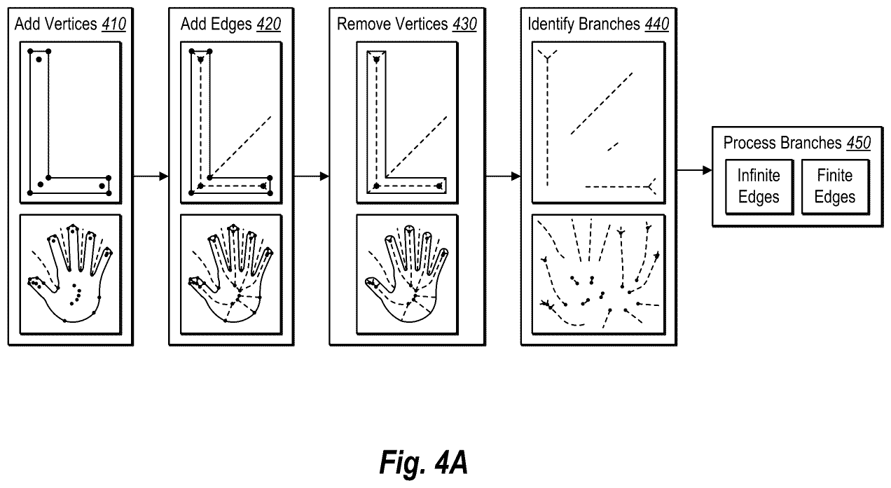

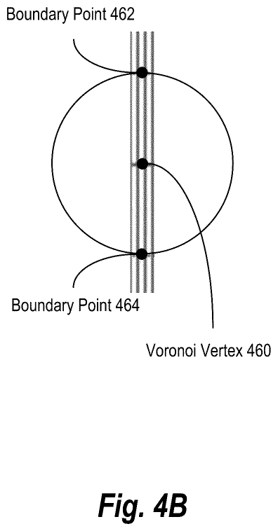

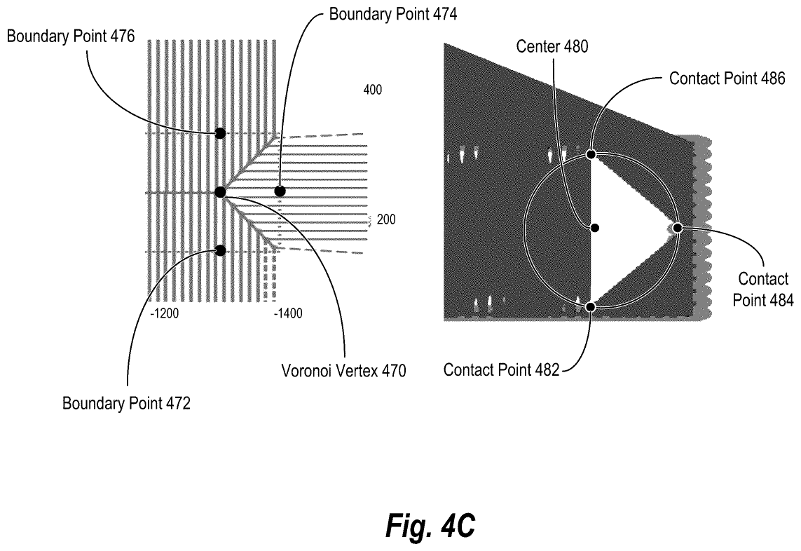

As mentioned, the stroke extraction system 106 filters the medial axis (e.g., internal and external medial axes) to generate an undirected graph that represents the structure of the vector-based outline shape. FIGS. 4A-4C illustrate an example of generating an undirected graph to encode a medial axis in accordance with one or more embodiments.

As described above, the stroke extraction system 106 uses point samples of a vector-based outline as input to generate a Voronoi diagram and generate the medial axis. In this way, the stroke extraction system 106 generates a medial axis in the form of an undirected planar graph, constructed from edges that are connected at the Voronoi vertices. In some cases, the stroke extraction system 106 utilizes the undirected graph to manipulate the medial axis for stroke reconstruction.

As mentioned, the stroke extraction system 106 generates an undirected graph encoding the medial axis to capture the connectivity between different points (vertices) and branches (paths) of the medial axis. As shown in FIG. 4A, implementations of the stroke extraction system 106 generate an undirected graph encoding the medial axis for stroke-based text and/or stroke-based designs. For example, described in relation to FIG. 3, the stroke extraction system 106 performs an act 410 to add vertices to the undirected graph for each vertex obtained from the Voronoi diagram. In addition, as further described in relation to FIG. 3, the stroke extraction system 106 performs an act 420 to add graph edges for each edge obtained from the Voronoi diagram and associates each edge with the anchor points for the edge. Additionally, the stroke extraction system 106 performs an act 430 to delete any vertices of the undirected graph that are not connected by edges. In some cases, the unconnected vertices are remnants from the removal of spurious edges that do not contribute to the medial axis as described in relation to FIG. 3.

As described, in one or more embodiments, the stroke extraction system 106 generates a medial axis that includes vertices (e.g., terminals, forks), and branches utilizing maximal disks. To elaborate, a terminal vertex includes or refers to a vertex of the medial axis that has a degree of one, meaning the vertex is connected to only one other vertex in the undirected graph. To illustrate, a terminal vertex corresponds to the extrema of curvature or sharp corners of a vector-based shape. In addition, a fork includes or refers to a vertex of the medial axis with a degree of three or more, meaning the fork connected to three or more other vertices in the undirected graph. To illustrate, a fork corresponds to potential branching structures of the original vector-based shape and to the ends of polygonal strokes. Furthermore, a branch includes or refers to a series of end-to-end connected edges that start and end at a terminal or a fork, with interior vertices of degree two. In addition, a maximal disk includes or refers to a disk centered on a vertex with a radius which is a minimum distance from the vertex to the vector-based outline. To illustrate, a disk touches the vector-based outline at the number of points equal to the degree of its associated vertex. For example, a disk associated with a terminal (degree one) touches the vector-based outline at one distinct point, a disk associated with a vertex of degree two touches the vector-based outline at two distinct points, and a disk associated with a fork (degree three) touches the vector-based outline at three distinct points.

Furthermore, as part of constructing the undirected graph, the stroke extraction system 106 performs an act 440 to identify branches within the undirected graph. For example, a branch is a continuous sequence of edges starting and ending at either another fork, a terminal vertex, or forming a loop back to the starting fork. In some cases, the stroke extraction system 106 performs the act 440 by traversing the medial axis to identify distinct branches, which are defined as paths of connected edges starting from vertices with a degree of 3 (fork vertices) and ending at either another fork vertex, a terminal vertex (degree≠2), or the start of the branch in case of loops. In one or more embodiments, the stroke extraction system 106 utilizes an algorithm such as the following to identify the branches:

Get Graph Branches Algorithm

| 1: | procedure GETBRANCHES(graph) | |
|---|---|---|
| 2: | branches ← Empty list | > This list will store all the branches |
| 3: | visited ← Set of visited edges | > This set will store the first and last edge of |
| | | each visited branch so that we don't visit the |
| | | same branch twice when we come across it |
| | | from another fork |

| | |
|---|---|
| 4: | forkVertices ← List of vertices in graph having degree 3 |
| 5: | for each startVertex in forkVertices do |
| 6: | for each edge in adjacentEdges(startVertex) do |
| 7: | if edge not in visited then |
| 8: | Branch ← initiate a new branch starting from startVertex; |
| 9: | currentVertex ← startVertex |
| 10: | previousEdge ←None |
| 11: | while True do |
| 12: | nextEdge ← GETNEXTEDGE(currentVertex, previousEdge) |
| 13 | if nextEdge is None then |
| 14: | break |
| 15: | end if |
| 16: | nextVertex←GET GETOTHERENDOFEDGE(nextEdge, currentVertex) |
| 17: | Append nextVertex to Branch |
| 18: | if degree(nextVertex) is not 2 or nextVertex equals startVertex then |

> Stop at end of branch or in case of loop

| | |
|---|---|
| 19: | Add nextEdge to visited |
| 20: | break |
| 21: | end if |
| 22: | previousEdge ← nextEdge |
| 23: | currentEdge; ← nextVertex |
| 24: | end while |
| 25: | Append Branch to branches |
| 26: | end if |
| 27: | end for |
| 28: | end for |
| 29: | return branches |
| 30: | end procedure |
| 31: | procedure GETNEXTEDGE(vertex, previousEdge) |
| 32: | for each edge in adjacentEdges(vertex) do |
| 33: | if edge is not previousEdge then return edge |
| 34: | end if |
| 35: | end for |
| 36: | return None |
| 37: | end procedure |
| 38: | procedure GETOTHERENDOFEDGE(edge, vertex) |
| 39: | if edge.vertex1 equals vertex then return edge.vertex2 |
| 40: | else return edge.vertex1 |
| 41: | end if |
| 42: | end procedure |

In addition, as part of constructing the undirected graph, the stroke extraction system 106 performs the act 450 to process the branches identified in the act 440. For example, for each branch, the stroke extraction system 106 iterates through the vertices that form the edges of the branch. For example, for each edge, the stroke extraction system 106 determines an initial vertex for the edge and determines the corresponding maximal disk. In some embodiments, the stroke extraction system 106 reverses the branch if necessary to ensure an initial vertex at the base of the branch rather than the tip (e.g., processes the branch starting at the opposite vertex).

Furthermore, as part of constructing the undirected graph, the stroke extraction system 106 performs different operations for the act 450 based on the degree of the vertices. In some cases, if the edge is infinite (e.g., extends indefinitely), the stroke extraction system 106 assigns the center of the corresponding maximal disk at the finite vertex, assigns the radius of the maximal disk to an arbitrary large value, and assigns the contact points of the maximal disk as the anchor points of the edge.

In some cases, if the edge is finite, the stroke extraction system 106 performs operations as shown in FIGS. 4B-4C. For example, as shown in FIG. 4B, for vertices with a degree of two, each point along the edge is equidistant from just two boundary points (e.g., boundary point 462 and boundary point 464) on the vector-based outline. In addition, as shown, the stroke extraction system 106 determines a maximal disk that touches the vector-based outline at the two boundary points. The stroke extraction system 106 determines the maximal disk for the vertex (e.g., Voronoi vertex 460) to be a maximal disk where the center of the disk is calculated as the midpoint of the two boundary points, and the radius is the distance from the center to either boundary point.

As shown in FIG. 4C, for vertices with a degree of three (e.g., Voronoi vertex 470), the maximal disk touches the vector-based outline at three boundary points (e.g., boundary point 472, boundary point 474, and boundary point 476). The stroke extraction system 106 determines the three boundary points correspond to the Delaunay triangle associated with the Voronoi vertex. In this case, the stroke extraction system 106 determines a fork disk, wherein the fork disk is a maximal disk with a center 480 corresponding to the vertex and a radius corresponding to the shortest distance to a boundary of the vector-based outline shape. For example, the stroke extraction system 106 determines a fork disk defined by the circumcircle of the Delaunay triangle, where the center 480 and radius of the disk match the circumcircle, and the contact points correspond to where the maximal disk touches the vector-based outline shape (e.g., contact point 482, contact point 484, and contact point 486).

In addition, the stroke extraction system 106 utilizes the same process shown in FIG. 4C for degree-one vertices (terminals). For example, for degree-one vertices, the stroke extraction system 106 uses the circumcircle of the corresponding Delaunay triangle to define the maximal disk. The stroke extraction system 106 repeats the process illustrated in FIG. 4C for any remaining vertices that haven't been assigned maximal disks, ensuring all vertices in each branch are processed and assigned maximal disks.

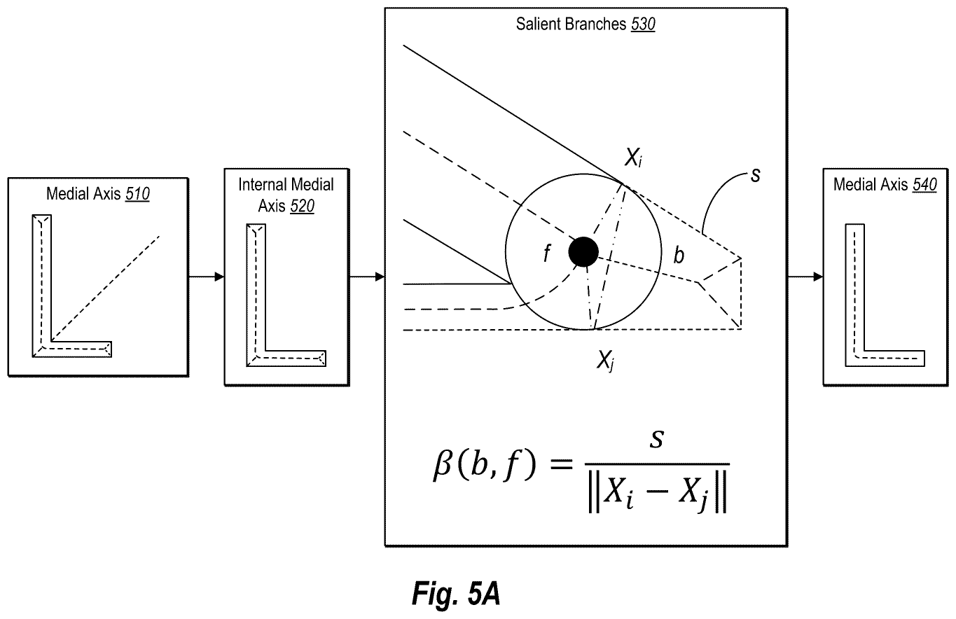

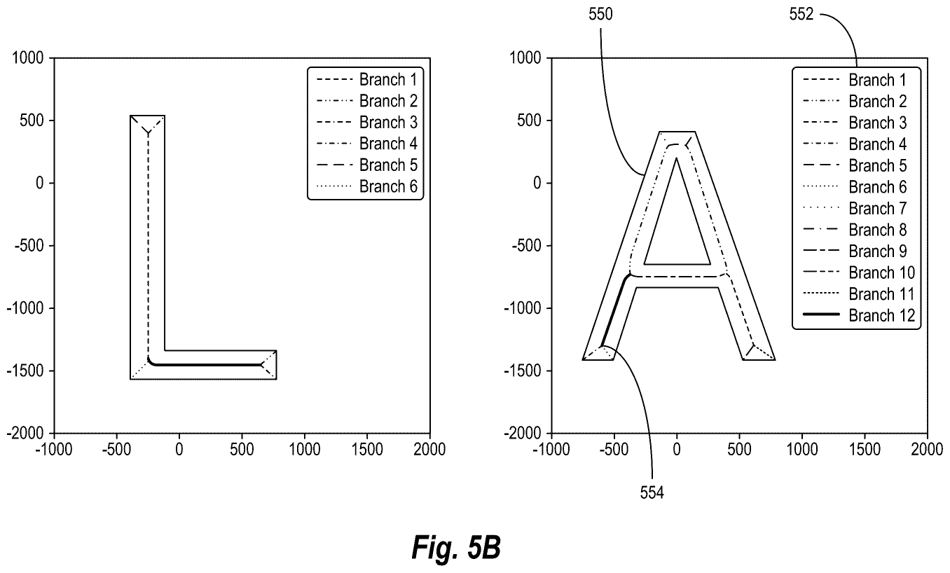

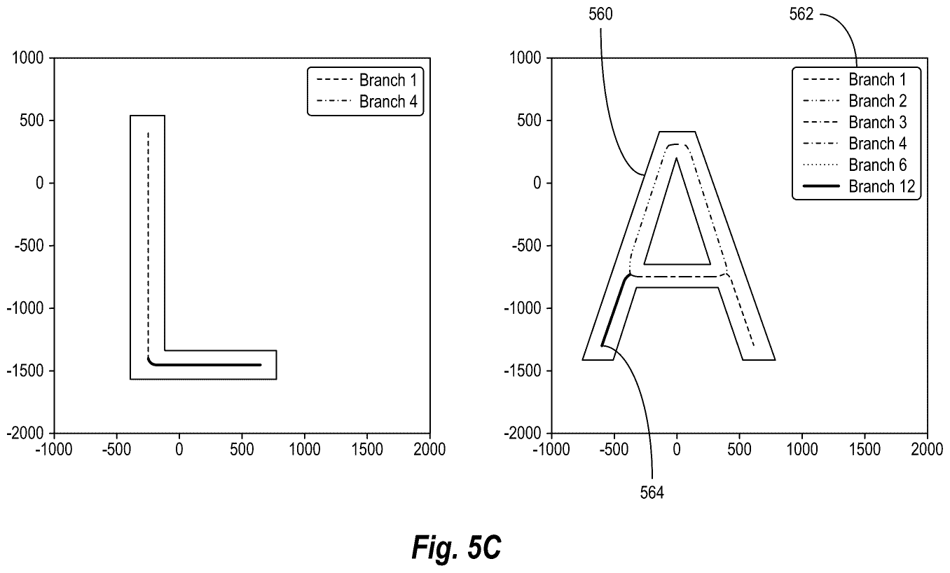

As mentioned, the stroke extraction system 106 prunes external and non-salient branches from the medial axis to generate an undirected graph that represents the vector-based shape. FIGS. 5A-5C illustrate an example of pruning the external and non-salient branches from the medial axis in accordance with one or more embodiments.

As discussed above, the stroke extraction system 106 determines or isolates an internal medial axis 520 by removing branches that are located outside of the vector-based outline. In one or more embodiments, the stroke extraction system 106 using an algorithm such as the following to remove external branches and generate the internal medial axis 520:

Filter and Remove Branches Based on Point Location Algorithm

| | |
|---|---|
| 1: | procedure FILTERGRAPH(graph, shape) |
| 2: | branches ← GETBRANCHES(graph) |
| 3: | for each branch in branches do |
| 4: | if len(branch) > 2 then > Only consider branches with more than 2 |

vertices

| | |
|---|---|
| 5: | pointl ← branch[l] |
| 6: | midPoint← branch[[len(branch)/2]] |
| 7: | point2 ← branch[len(branch) − 2] |
| 8: | if NOT (IslnsideShape(pointl, shape) AND |

IslnsideShape(midPoint, shape) AND IslnsideShape(point2, shape)) then

| | |
|---|---|
| 9: | REMOVEBRANCH (branch) |
| 10: | end if |
| 11: | else |
| 12: | midPoint ← branch[[len(branch)/2]] |
| 13: | if NOT (IslnsideShape(midPoint, shape)) then |
| 14: | REMOVEBRANCH(branch) |
| 15: | end if |
| 16: | end if |
| 17: | end for |
| 18: | end procedure |
| 19: | procedure REMOVEBRANCH(branch) |
| 20: | for each vertex in branch do |
| 21: | Delete vertex and its incident edges from the graph |
| 22: | end for |
| 23: | end procedure |

To illustrate, as shown in FIG. 5B, the stroke extraction system 106 determines internal branches for the medial axis (and the undirected graph) for the vector-based outline. As shown, the internal branches connect at vertices and include salient and non-salient branches. For example, the stroke extraction system 106 generates, from the vector-based outline shape, an undirected graph encoding a medial axis corresponding to features of a vector-based outline 550 (e.g., “A”). As shown, the medial axis includes multiple internal branches 552. As also shown, the medial axis includes multiple forks such as vertex 554 where a first branch, a second branch, and a third branch connect.

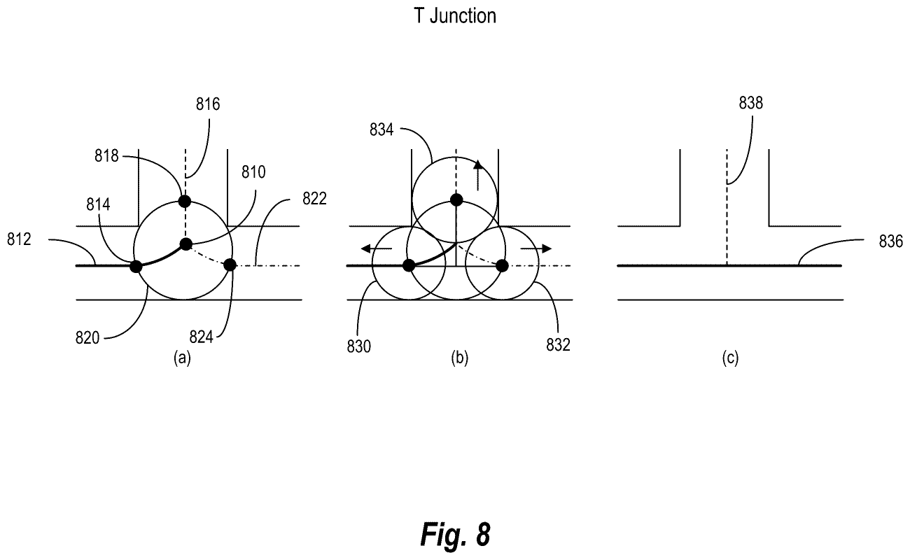

Turning back to FIG. 5A, in one or more embodiments, the stroke extraction system 106 removes non-salient branches and retains salient branches 530. For example, the stroke extraction system 106 removes non-salient branches that are visually redundant or structurally superfluous for stroke reconstruction. In some cases, the stroke extraction system 106 removes non-salient branches at stroke ends, corners, and elbows. In one or more embodiments, the stroke extraction system 106 utilizes chord residual regularization to determine the edges of the medial axis that capture the topological properties of the vector-based shape by removing the non-salient branches. In certain embodiments, the stroke extraction system 106 removes the non-salient branches when processing the junction transitions as described in relation to FIGS. 8-12 to improve the computational efficiency of the system.

To illustrate, the stroke extraction system 106 determines a branch salience to differentiate between medial axis branches that represent the main part of a stroke and medial axis branches that arise from the end of a path or a corner. For example, as shown in FIG. 5, the stroke extraction system 106 determines a branch salience for a branch b protruding from a fork f (e.g., a fork vertex). In some cases, the stroke extraction system 106 orients a branch starting from a fork f. Additionally, the stroke extraction system 106 determines a length of the outline segment s of the vector-based outline that links the points Xᵢ and Xⱼ that are the contact points of the fork disk for the fork f.

To illustrate, the stroke extraction system 106 selects the outline segment s corresponding to the branch b. For example, the stroke extraction system 106 selects a segment s that also includes at least two additional points that are the contact points of the disk at the other end of the branch (e.g., the segment that is outside the branch b). In some cases, the stroke extraction system 106 determines pairs of contact points of a fork f (e.g., 3 possible pairs based on different combinations of the three contact points). For each pair, out of the 2 possible outline segments of the vector-based outline, the stroke extraction system 106 selects the outline segment s that also contains at least 2 of the points for the maximal disk at the other vertex for branch b. Furthermore, out of the 3 pairs, the stroke extraction system 106 selects the pair Xᵢ and Xⱼ that corresponds to the smallest outline segment s. To illustrate, in one or more embodiments, the stroke extraction system 106 determines the contact points Xᵢ and Xⱼ using an algorithm such as the following:

Find the Outline Segment and Fork points for Branch Salience Algorithm

| 1: | procedure FINDSEGMENT(forkContactPoints, branchEndpointContactPoints, outline) | |
|---|---|---|
| 2: | smallestSegmentLength, < ∞ | |
| 3: | chosenForkContactPoints ← NULL | > Initialize the variables |
| 4: | for each pair in POSSIBLEPAIRS(forkContactPoints) do | |
| 5: | selectedSegment ← SELECTSEGMENT(pair, branchEndpointContactPoints, | |
| outline) | | > Select segment that has intersection |
| 6: | if LENGTH(selectedSegment) < smallestSegmentLength then | |
| 7: | smallestSegmentLength ← LENGTH (selectedSegment) | |
| 8: | chosenForkContactPoints ← pair | > Update if current segment is |

the smallest

| 9: | end if | |
|---|---|---|
| 10. | end for | |
| 11: | return smallestSegmentLength, ChosenForkContactPoints | |
| 12: | end procedure | |
| 13: | procedure POSSIBLEPAIRS(pointsList) | |
| 14: | pairs ← | > List to store the pairs |
| 15: | for i = 0 to LENGTH(pointsList) − 2 do | |
| 16: | for j = i + 1 to LENGTH(pointsList) − 1 do | |
| 17: | pairs ← pairs+ [pointsList[i], pointsList[j]] | > Create and add the |

pair to list

| | |
|---|---|
| 18: | end for |
| 19: | end for |
| 20: | return pairs |
| 21: | end procedure |
| 22: | procedure SELECTSEGMENT (pair, branchEndpointsContactPoints, outline) |
| 23: | for each segment in POSSIBLESEGMENTS(pair , outline) do |
| 24: | if INTERSECTION(segment, branchEndpointContactPoints) > 1 then |
| 25: | return segment |
| 26: | end if |
| 27: | end for |
| 28: | return NULL |
| 29: | end procedure |

In certain embodiments, the stroke extraction system 106 determines a branch salience for the branch b as a measure of the amount the outline segment s sticks out relative to the vector-based outline. For example, the stroke extraction system 106 determines the outline segment s on the vector-based outline shape associated with a target branch b such that endpoints of the outline segment s correspond to two intersection points Xᵢ and Xⱼ between the vector-based outline shape and a maximal disk centered at the fork f. In addition, the stroke extraction system 106 generates a saliency measure based on comparing a width of the vector-based outline shape between the two intersection points Xᵢ and Xⱼ to a length of the boundary segment s. In particular, the stroke extraction system 106 defines the branch salience as:

$$β ( b , f ) = \frac{s}{‖ {X}_{i} - {X}_{j} ‖}$$

In addition, the stroke extraction system 106 utilizes a saliency threshold to determine the salient branches 530. As shown, the branch salience quantifies the length of the outline segment s relative to its width at its point of attachment to the fork f. The stroke extraction system 106 determines the branch b is salient with respect to a fork f if it satisfies a saliency threshold β(b, f)>τβ. In some embodiments, the stroke extraction system 106 uses a saliency threshold of τβ=2.3. In some cases, where the intersection points Xᵢ and Xⱼ are on different paths the stroke extraction system 106 sets β(b, f) to an arbitrarily large value (e.g. when b is part of a loop surrounding a hole). After discarding non-salient branches (i.e. branches with saliency<Tβ), the stroke extraction system 106 determines the medial axis 540.

To illustrate, as shown in FIG. 5C, the stroke extraction system 106 prunes non-salient branches from the undirected graph. For example, as shown, the stroke extraction system 106 deletes non-salient branches with a saliency under the saliency threshold from the medial axis. In some cases, the stroke extraction system 106 determine salient branches 562 as a subset of the multiple internal branches 552 with the non-salient branches removed. As also shown, the vertex 564 (a terminal vertex) has one remaining salient branch connected and the two non-salient branches have been removed. In particular, the stroke extraction system 106 prunes, from the undirected graph (and medial axis), the non-salient branches connected at the vertex 564 based on the non-salient branches failing to satisfy the saliency threshold τβ.

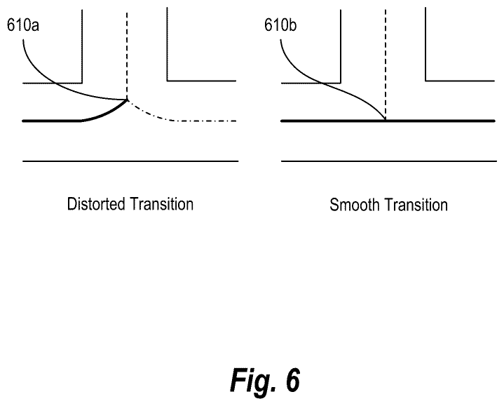

As mentioned, in many cases, the branches of the medial axis are more in number than are perceived visually. The stroke extraction system 106 merges and refines the branches at junctions to mimic hand tracing of the vector-based shape based on the latent stroke structure of a stroke-based design. In this way, the stroke extraction system 106 merges the branches of the medial axis to provide simple, yet coherent, strokes to represent the vector-based shape in a way that makes sense visually. FIG. 6 illustrates an example of merging and refining branches of the medial axis at a vertex in accordance with one or more embodiments.

For example, the stroke extraction system 106 modifies the transitions at vertices to account for distorted transitions or excess strokes. Each branch in the medial axis has at least one endpoint at a fork (as described in relation to act 440 and the “Get Graph Branches Algorithm”). The stroke extraction system 106 utilizes the trait that forks often correspond to distorted areas in the medial axis by identifying and processing the forks to determine the intrinsic direction of each branch and how the branches should be merged or corrected. Each fork is located in a specific area of the vector-based outline, so by processing all the forks, the stroke extraction system 106 determines the stroke decomposition of the vector-based shape.

To illustrate, as shown in FIG. 6, the medial axis at the vertex 610a is both distorted and visually portrays a discontinuous stroke. For example, the horizontal stroke associated with vertex 610a should be a single continuous stroke, instead of two discontinuous strokes. Notably, the occurrence of split strokes such as shown in vertex 610a increase as the font glyphs become more complex. In one or more embodiments, the stroke extraction system 106 smooths and combines segments at the vertex 610a to correct the strokes as shown in vertex 610b.

To elaborate, the stroke extraction system 106 refines the structure of the undirected graph at each fork. For example, to refine the undirected graph, the stroke extraction system 106 filters the non-salient branches, identifies branch tangents, merges branches based on the branch tangents, and adjusts the remaining branches. The stroke extraction system 106 determines the type of transition and adjusts the remaining branches based on the type of junction (as described in greater detail in FIGS. 8-12). In one or more embodiments, the stroke extraction system 106 utilizes an algorithm such as the following to process the vertices of the undirected graph:

Junction Processing Algorithm

| | |
|---|---|
| 1: | procedure PROCESSJUNCTIONS(graph) |
| 2: | forkVertices ← List of vertices in graph having degree 3 |
| 3: | for each forkVertex in forkVertices do |
| 4: | retainedBranches ← Empty list |
| 5: | for each branch in GETBRANCHESFROMFORK(forkVertex, graph) do |
| | > Get branches incident at fork, oriented starting |
| | from fork |
| 6: | saliency ← BRANCHSALIENCY(branch) |
| 7: | if saliency > 2.3 then |
| 8: | Add branch to retainedBranches |
| 9: | else |
| 10: | REMOVEBRANCH(branch) |
| 11: | end if |
| 12: | end for |
| 13: | spokes ← Empty List > Regions inside fork disks are considered distorted |

and are discarded. Spoke represents the first tangent edge outside the fork disk.

| | |
|---|---|
| 14: | for each branch in retainedBranches do |
| 15: | Add GETSPOKE(branchGraph) to spokes |
| 16: | end for candidates ← Empty list |
| 17: | for each pair of spokes do |
| 18: | angle ← angle between pair |
| 19: | if angle > 170 and angle < 190 then |
| 20: | Add \|180 − angle\| to candidates |
| 21: | end if |
| 22: | end for |
| 23: | if len(candidates) > 0 then |
| 24: | toMerge ←branch corresponding to min(candidates) |
| 25: | end if |
| 26: | MERGEBRANCHES(toMerge) |
| 27: | ADJUSTBRANCHES(forkVertex, graph)) |
| 28: | end for |
| 29: | end procedure |

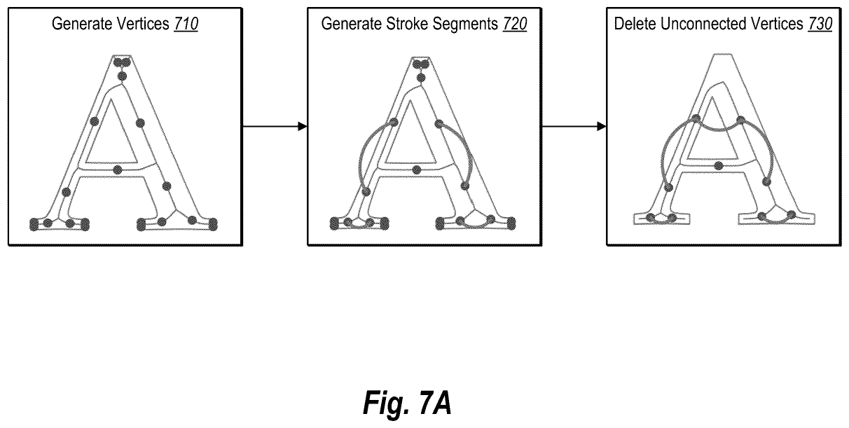

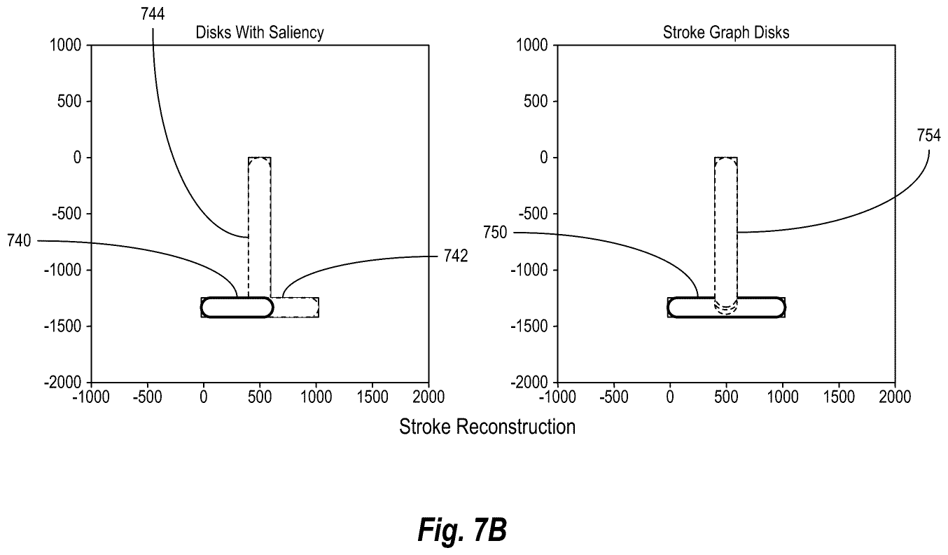

As mentioned, the stroke extraction system 106 transforms the medial axis branches into strokes using a stroke graph. FIGS. 7A-7B illustrate converting a medial axis into a stroke graph to capture the structure and properties of the vector-based outline shape using strokes in accordance with one or more embodiments.

As shown in FIG. 7A, the stroke extraction system 106 transforms the medial axis branches into a stroke graph which includes stroke vertices, stroke spines, and stroke widths. For example, the stroke extraction system 106 performs the act 710 to associate a vertex in the stroke graph with each branch of the medial axis. For example, for every distinct path in the medial axis (branch), the stroke extraction system 106 generates a corresponding node or point in the stroke graph. In some cases, the stroke extraction system 106 determines stroke graph vertices based on path centers of the medial axis. The stroke extraction system 106 utilizes vertices in the stroke graph as the points where information about the medial axis is stored and processed.

Furthermore, the stroke extraction system 106 performs the act 720 to determine a stroke spine associated with the path centers of the medial axis. For example, the stroke extraction system 106 utilize the stroke spine as the central path of a stroke associated with the path followed by the medial axis along a branch. To elaborate, the stroke extraction system 106 determines the stroke spine as the core line that runs through the middle of a stroke, tracing the route of the branch from the medial axis and representing the general direction and shape of the stroke.

In addition, the stroke extraction system 106 determines a stroke width associated with the radii of the medial axis disks. For example, the stroke extraction system 106 determines the stroke width based on the radii of the maximal disks at each point along the branch. The radius of each maximal disk corresponds to how thick the stroke is at that particular part of the vector-based shape. For example, when determining a stroke width along a branch between two points, the stroke extraction system 106 interpolates between the radii of the two points. The stroke extraction system 106 utilizes the vertices of the stroke graph (each vertex representing a branch) to hold this width information and define the overall thickness of the stroke.

As also shown, the stroke extraction system 106 performs the act 730 to delete unconnected vertices associated with non-salient branches. For example, the stroke extraction system 106 deletes unconnected vertices that are remnants of the removal of the spurious edges that do not contribute to the medial axis.

As illustrated in FIG. 7B, the stroke extraction system 106 merges strokes to generate simple, coherent strokes. In particular, the stroke extraction system 106 performs logical operations on the stroke graph to merge the strokes. For example, to merge two branches, the stroke extraction system 106 adds an edge between the corresponding vertices in the stroke graph. For example, to delete non-salient branches, the stroke extraction system 106 discards the corresponding vertex is discarded from the stroke graph. After the stroke extraction system 106 performs the merging and deletion operations, each connected component of the stroke graph represents one particular stroke in the final stroke design.

To elaborate, the stroke extraction system 106 performs adjustment operations on the stroke graph to correct distorted parts of the medial axis. The stroke extraction system 106 identifies the fork disks of the medial axis and evaluates the branch segments within fork disk to determine if the branch segments are distorted. In turn, the stroke extraction system 106 corrects distorted segments to create smooth, coherent strokes. In particular, the stroke extraction system 106 utilizes transitions that replace portions of one or more stroke segments with ones that smoothly interpolate between an initial and final pair of points. In one or more embodiments, the stroke extraction system 106 utilizes transitions that replace portions of one or more stroke segments with ones that smoothly interpolate between an initial and final pair of centers and radii (yᵢ, rᵢ) and (yⱼ, rⱼ).

The stroke extraction system 106 determines the type of transition based on the type of junction (as described in greater detail in FIGS. 8-12). For example, the stroke extraction system 106 replaces stroke ends using straight transitions and T-like junctions using smoothing transitions and/or straight transitions. When using a straight transition, the stroke extraction system 106 connects the initial and final centers with a straight spine. To illustrate, the stroke extraction system 106 uses a straight spine connecting the initial and final centers yᵢ and yⱼ with a constant width profile (rᵢ=rⱼ=r).

In some cases, the stroke extraction system 106 utilizes a smoothing transition to replace distorted segments with smoothly interpolated ones. The stroke extraction system 106 utilizes a smoothing transition to generate a spine by sampling points along a clothoid (a curve whose curvature changes linearly with its length), wherein the clothoid curve comprises a curvature change adjusted to match the first tangent and the second tangent. For example, the stroke extraction system 106 utilizes a clothoid curve which connects the initial and final centers yᵢ and yⱼ, with disk radii that interpolate linearly between the initial and final radii rᵢ and rⱼ. In some cases, the stroke extraction system 106 reduces the clothoid to a straight-line segment.

In some embodiments, the stroke extraction system 106 optimizes the clothoid parameters using a secant-based method, ensuring that the resulting transition fits well with the original shape. For example, the stroke extraction system 106 uses the secant-based method to iteratively adjust the curve parameters to minimize the error and ensure that the curve smoothly connects two points with the desired tangents based on a rate of change of curvature along the portion of the branch. In some cases, the stroke extraction system 106 optimizes by starting with an initial guess for the clothoid parameters. Using a secant-based method, the stroke extraction system 106 computes an error in the tangents at the endpoints (how far the actual tangent of the clothoid deviates from the desired tangent) and then iteratively adjusts the clothoid parameters, aiming to minimize the error. In this way, the stroke extraction system 106 optimizes the parameters of the clothoid curve using two initial approximations without requiring the computational expense of calculating derivatives.

To illustrate, as shown in FIG. 7B, the stroke extraction system 106 uses a smoothing transition to merge two stroke segments into a composite stroke segment based on the transition. For example, the stroke extraction system 106 converts the stroke segment 740 and stroke segment 742 into a single stroke segment, stroke segment 750. In addition, the stroke extraction system 106 uses a straight transition to extend stroke segment 744 as shown by stroke segment 754. The transition used by the stroke extraction system 106 for a T-junction (as illustrated in FIG. 7B) is discussed in more detail in relation to FIG. 8 below.

FIGS. 8-12 illustrate determining and utilizing one or more transition types based on a junction type. As mentioned, the stroke extraction system 106 performs transitions at the vertices of the undirected graph based on the type of junction utilizing straight transitions and/or smoothing transitions. For example, the stroke extraction system 106 determines a type of junction at the vertex by comparing tangents of the branches connected to the vertex. In some embodiments, the stroke extraction system 106 determines junction types including T-junctions, Y-junctions, L-junctions, crossing junctions, and terminal junctions.

For example, in relation to FIGS. 8-12, the stroke extraction system 106 determines the saliency of the branches connected to vertices of the undirected graph. If the saliency of a branch satisfies the saliency threshold, the branch is retained. In contrast, if the branch does not satisfy the saliency threshold, the branch is discarded. Based on the remaining branches (e.g., salient branches), the stroke extraction system 106 merges and refines the branches utilizing the rules summarized below in relation to FIGS. 8-12.

As shown, FIG. 8 illustrates the stroke extraction system 106 performing a transition for the branches connecting to a vertex at a T-junction in accordance with one or more embodiments. As shown, when all three branches are salient, the stroke extraction system 106 determines if the junction is a T-junction. For example, the stroke extraction system 106 determines the junction is a T-junction by determining any pair of branches make an angle of nearly 180 degrees (e.g., between approximately 170-190 degrees).

To determine that any pair of branches make an angle of nearly 180 degrees, the stroke extraction system 106 utilizes the maximal disk 820. For example, the stroke extraction system 106 determines a maximal disk 820 (e.g., a fork disk) centered at the vertex 810. As mentioned, the stroke extraction system 106 determines the maximal disk 820 as a disk with radii corresponding to the shortest distance from the vertex 810 to the boundary of the vector-based outline. In turn, the stroke extraction system 106 determines a point 814 on the branch 812 outside where the branch 812 intersects with the maximal disk 820. To elaborate, the stroke extraction system 106 determines the point 814 as a point on the branch 812 outside the maximal disk 820 which is closest to the maximal disk 820. Similarly, the stroke extraction system 106 determines a point 818 on the branch 816 outside where the branch 816 intersects with the maximal disk 820. Similarly, the stroke extraction system 106 determines a point 824 on the branch 822 outside where the branch 822 intersects with the maximal disk 820. As shown, the point 814, the point 818, and the point 824 are points just outside the maximal disk 820. In some embodiments, the stroke extraction system 106 determines the point 814 as the point where the branch 812 intersects with the maximal disk 820, the point 818 as the point where the branch 816 intersects with the maximal disk 820, and the point 824 as the point where the branch 822 intersects with the maximal disk 820.

In some cases, the stroke extraction system 106 compares a tangent of a first branch outside the fork disk (e.g., the tangent of the branch at the position immediately outside the fork disk) and a tangent of the second branch outside the fork disk to determine the type of junction at the vertex. For example, the stroke extraction system 106 compares the tangents of the branches at the point 814, the point 818, and the point 824 to determine the junction is a T-junction if the angle between the tangents is nearly 180 degrees (e.g., between approximately 170 to 190 degrees). As shown, the tangent t₈₁₄ of the branch 812 at point 814 and the tangent t₈₂₄ of the branch 822 at point 824 make an angle of nearly 180 degrees. Based on the angle between the branch 812 and the branch 822, the stroke extraction system 106 selects the branch 812 and the branch 822 as the pair of branches to be merged using a smoothing transition.

Furthermore, the stroke extraction system 106 adjusts the branch 812 and the branch 822 at the vertex 810 based on the angle between the tangent t₈₁₄ and the tangent t₈₂₄. For example, to merge the branch 812 and the branch 822 using a smoothing transition, the stroke extraction system 106 utilizes the tangents t₈₁₄ and t₈₂₄ outside the fork disk and the associated radii r₈₁₄ and r₈₂₄. To elaborate, the stroke extraction system 106 determines a maximal disk 830 for the point 814 with a radius r₈₁₄ corresponding to a shortest distance from the point 814 to the boundary of the vector-based outline. As also shown, the stroke extraction system 106 determines a maximal disk 832 for the point 824 with a radius r₈₂₄ corresponding to a shortest distance from the point 824 to the boundary of the vector-based outline.

In addition, as described above, the stroke extraction system 106 utilizes a smoothing transition to generate a spine by sampling points along a clothoid, wherein the clothoid curve comprises a curvature change adjusted to match the tangent t₈₁₄ and the tangent t₈₂₄. For example, the stroke extraction system 106 utilizes a clothoid curve which connects the point 814 and the point 824 with disk radii that interpolate linearly between the initial and final radii r₈₁₄ and r₈₂₄. As described, the stroke extraction system 106 determines, based on the radii r₈₁₄ and r₈₂₄ and the interpolated disk radii, a stroke width along the branch between the point 814 and the point 824.

In addition, the stroke extraction system 106 uses a straightening transition on the branch 816. In particular, the stroke extraction system 106 extends the branch 816 using a straightening transition to intersect with the composite branch 838. For example, the stroke extraction system 106 generates a straight spine to connect the point 818 on the branch 816 to the composite branch 836 using a constant width profile (e.g., based on the radius of a maximal disk 834 at the point 818).

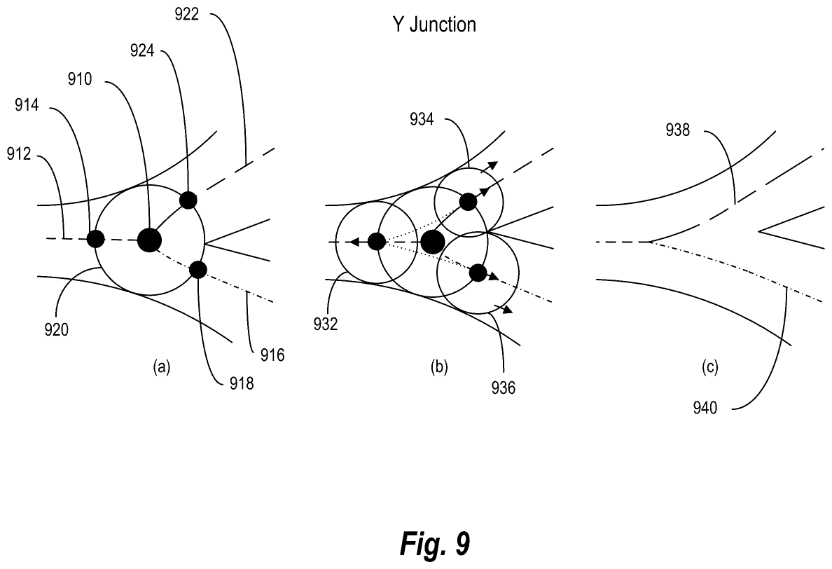

FIG. 9 illustrates the stroke extraction system 106 performing a transition for the branches connecting to a vertex at a Y-junction in accordance with one or more embodiments. As shown, if all three branches are salient, the stroke extraction system 106 determines if the junction is a Y-junction. The stroke extraction system 106 determines the junction is a Y-junction by determining that no pair of branches make an angle of nearly 180 degrees (e.g., between approximately 170-190 degrees). Upon determining the junction is a Y-junction, the stroke extraction system 106 performs two smoothing transitions. In some cases, the stroke extraction system 106 performs the two soothing transitions for a Y-junction without performing any merging operations between the branches (e.g., branch 912, branch 916, and branch 922), instead smoothing the branches to fix a distortion of the medial axis at the fork.

To determine that no pairs of branches make an angle of nearly 180 degrees, the stroke extraction system 106 utilizes the maximal disk 920. For example, the stroke extraction system 106 determines a maximal disk 920 (e.g., a fork disk) centered at the vertex 910. As mentioned, the stroke extraction system 106 determines the maximal disk 920 as a disk with radii corresponding to the shortest distance from the vertex 910 to the boundary of the vector-based outline. In turn, the stroke extraction system 106 determines a point 914 on the branch 912 outside where the branch 912 intersects with the maximal disk 920. Similarly, the stroke extraction system 106 determines a point 918 on the branch 916 outside where the branch 916 intersects with the maximal disk 920. Similarly, the stroke extraction system 106 determines a point 924 on the branch 922 outside where the branch 922 intersects with the maximal disk 920. As shown, the point 914, the point 918, and the point 924 are points just outside the maximal disk 920. In some embodiments, the stroke extraction system 106 determines the point 914 as the point where the branch 912 intersects with the maximal disk 920, the point 918 as the point where the branch 916 intersects with the maximal disk 920, and the point 924 as the point where the branch 922 intersects with the maximal disk 920.

In some embodiments, the stroke extraction system 106 compares the tangent of branches outside the fork disk (e.g., the tangents of the branches at the position immediately outside the fork disk) to determine the type of junction at the vertex. For example, the stroke extraction system 106 compares the tangents of the branches at the point 914, the point 918, and the point 924 to determine if the junction is a Y-junction. As shown, the none of the differences between the tangent t₉₁₄ of the branch 912 at point 914 and the tangent t₉₁₈ of the branch 916 at point 918 and the tangent t₉₂₄ of the branch 922 at point 924 correspond to an angle of nearly 180 degrees. Based on a comparison of the tangent t₉₁₄ and the tangent 914 and the tangent t₉₁₄, the stroke extraction system 106 determines the junction is a Y-junction.

Furthermore, based on the angles between the branch 912, the branch 916, and the branch 922, the stroke extraction system 106 determines which branches to transform utilizing a smoothing transition. In particular, based on a comparison of the tangent t₉₁₄ and the tangent t₉₁₄ and the tangent t₉₁₄, stroke extraction system 106 selects the branch 912 and the branch 922 as one pair to be merged using a smoothing transition. Similarly, based on a comparison of the tangent 1914 and the tangent t₉₁₄ and the tangent t₉₁₄, stroke extraction system 106 selects the branch 912 and the branch 916 as one pair to be merged using a smoothing transition. As shown, the stroke extraction system 106 selects the 2 pairs of branches that make the largest angles to merge with a smoothing transition (e.g., the angle between point 914 and point 918 is greater than the angle between point 918 and point 924 and the angle between point 914 and point 924 is greater than the angle between point 918 and point 924).

Furthermore, the stroke extraction system 106 adjusts the branch 912 and the branch 922 at the vertex 910 based on the angle between the tangent t₉₁₄ and the tangent t₉₂₄. For example, to merge the branch 912 and the branch 922 using a smoothing transition, the stroke extraction system 106 utilizes the tangents t₉₁₄ and t₉₂₄ outside the fork disk and the associated radii r₉₁₄ and r₉₂₄. To elaborate, the stroke extraction system 106 determines a maximal disk 932 for the point 914 with a radius r₉₁₄ corresponding to a shortest distance from the point 914 to the boundary of the vector-based outline. As also shown, the stroke extraction system 106 determines a maximal disk 934 for the point 924 with a radius r₉₂₄ corresponding to a shortest distance from the point 924 to the boundary of the vector-based outline. As also shown, the stroke extraction system 106 determines a maximal disk 936 for the point 918 with a radius r₉₁₈ corresponding to a shortest distance from the point 918 to the boundary of the vector-based outline.

In addition, as described above, the stroke extraction system 106 utilizes a smoothing transition to generate a spine by sampling points along a clothoid, wherein the clothoid curve comprises a curvature change adjusted to match the tangent t₉₁₄ and the tangent t₉₂₄. For example, the stroke extraction system 106 utilizes a clothoid curve which connects the point 914 and the point 924 with disk radii that interpolate linearly between the initial and final radii r₉₁₄ and r₉₂₄. As described, the stroke extraction system 106 determines, based on the radii r₉₁₄ and r₉₂₄ and the interpolated disk radii, a stroke width along the branch between the point 914 and the point 924. As shown, the stroke extraction system 106 generates the composite branch 938 based on the smoothing transition.

Similarly, the stroke extraction system 106 adjusts the branch 912 and the branch 916 at the vertex 910 based on the angle between the tangent t₉₁₄ and the tangent t₉₁₈. For example, to merge the branch 912 and the branch 916 using a smoothing transition, the stroke extraction system 106 utilizes the tangents t₉₁₄ and t₉₁₈ outside the fork disk and the associated radii r₉₁₄ and r₉₁₈. To elaborate, the stroke extraction system 106 determines a maximal disk 934 for the point 924 with a radius r₉₂₄ corresponding to a shortest distance from the point 924 to the boundary of the vector-based outline.

In addition, as described above, the stroke extraction system 106 utilizes a smoothing transition to generate a spine by sampling points along a clothoid, wherein the clothoid curve comprises a curvature change adjusted to match the tangent t₉₁₄ and the tangent t₉₁₈. For example, the stroke extraction system 106 utilizes a clothoid curve which connects the point 914 and the point 918 with disk radii that interpolate linearly between the initial and final radii r₉₁₄ and r₉₁₈. As described, the stroke extraction system 106 determines, based on the radii r₉₁₄ and r₉₁₈ and the interpolated disk radii, a stroke width along the branch between the point 914 and the point 918. As shown, the stroke extraction system 106 generates the composite branch 940 based on the smoothing transition.

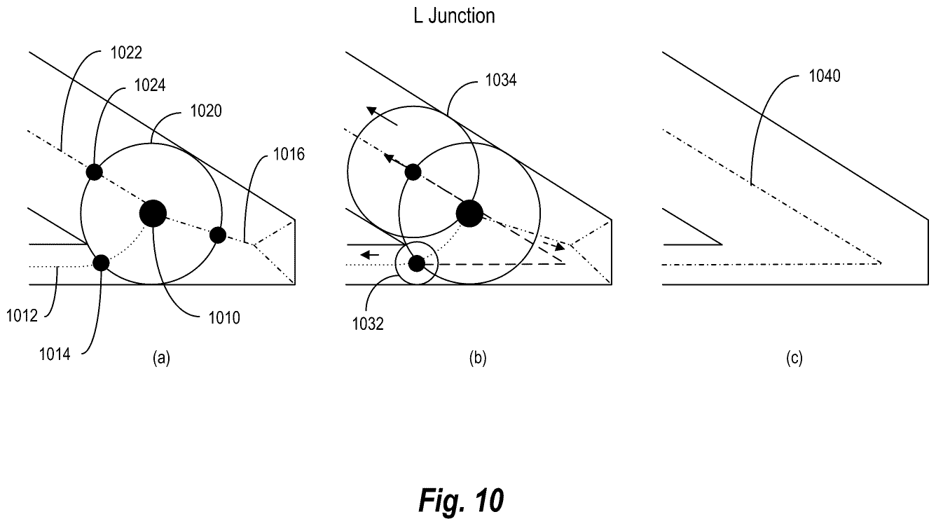

FIG. 10 illustrates the stroke extraction system 106 performing a transition for the branches connecting to a vertex at a L-junction in accordance with one or more embodiments. As shown, if two branches at the vertex are salient and one branch is non-salient, the stroke extraction system 106 determines the junction is an L-junction. In addition, the stroke extraction system 106 discards the non-salient branch based on a saliency threshold as described in relation to FIGS. 5A-5C.

Upon determining the junction is an L-junction, the stroke extraction system 106 uses a straightening transition on branch 1016 and branch 1022. In particular, the stroke extraction system 106 extends the branch 1016 and the branch 1022 utilizing two straightening transitions until they intersect.

To elaborate, the stroke extraction system 106 determines a maximal disk 1020 (e.g., a fork disk) centered at the vertex 1010. In addition, the stroke extraction system 106 determines a point 1014 on the branch 1012 outside where the branch 1012 intersects with the maximal disk 1020. Similarly, the stroke extraction system 106 determines a point 1024 on the branch 1022 outside where the branch 1022 intersects with the maximal disk 1020. As shown, the point 1014 and the point 1024 are points just outside the maximal disk 1020. In some embodiments, the stroke extraction system 106 determines the point 1014 as the point where the branch 1012 intersects with the maximal disk 820 and the point 1024 as the point where the branch 1022 intersects with the maximal disk 1020.

In addition, the stroke extraction system 106 determines the radii the maximal disks at the point 1014 and the point 1024. To elaborate, the stroke extraction system 106 determines a maximal disk 1032 for the point 1014 with a radius r₁₀₁₄ corresponding to a shortest distance from the point 1014 to the boundary of the vector-based outline. As also shown, the stroke extraction system 106 determines a maximal disk 1034 for the point 1024 with a radius r₁₀₂₄ corresponding to a shortest distance from the point 1024 to the boundary of the vector-based outline

As shown, the stroke extraction system 106 uses a straightening transition on the branch 1012 and branch 1022. In particular, the stroke extraction system 106 extends the branch 1012 and branch 1022 to intersect using straightening transitions. For example, the stroke extraction system 106 generates a straight spine from the point 1014 on the branch 1012 using a constant width profile based on r₁₀₁₄. In addition, the stroke extraction system 106 generates a straight spine from the point 1024 on the branch 1022 using a constant width profile based on r₁₀₂₄. As shown, the stroke extraction system 106 merges the branch 1012 and the branch 1022 to generate the composite branch 1040.

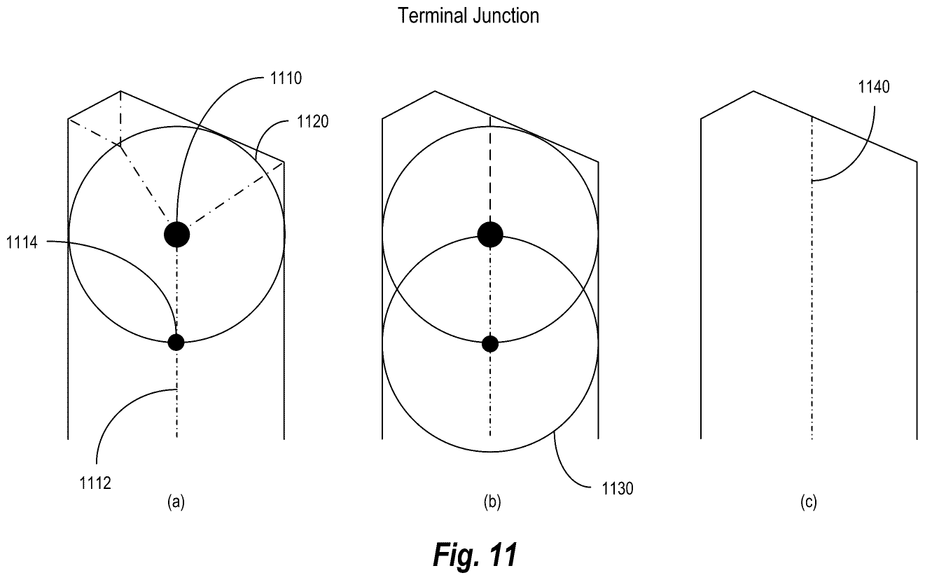

FIG. 11 illustrates the stroke extraction system 106 performing a transition for the branches connecting to a vertex at a terminal junction in accordance with one or more embodiments. As shown, if one branch at the vertex is salient and the remaining branches are non-salient, the stroke extraction system 106 determines the junction is a terminal junction. In addition, the stroke extraction system 106 discards the non-salient branches based on a saliency threshold as described in relation to FIGS. 5A-5C.

Upon determining the junction is a terminal junction, the stroke extraction system 106 uses a straightening transition on branch 1112. In particular, the stroke extraction system 106 extends the branch 1112 until it intersects with the vector-based outline.

To elaborate, the stroke extraction system 106 determines a maximal disk 1120 (e.g., a fork disk) centered at the vertex 1110. In addition, the stroke extraction system 106 determines a point 1114 on the branch 1112 outside where the branch 1112 intersects with the maximal disk 1120. As shown, the point 1114 is a point just outside the maximal disk 1120. In some embodiments, the stroke extraction system 106 determines the point 1114 as the point where the branch 1112 intersects with the maximal disk 1120. In addition, the stroke extraction system 106 determines the radius of the maximal disk at the point 1114. To elaborate, the stroke extraction system 106 determines a maximal disk 1130 for the point 1114 with a radius r₁₁₁₄ corresponding to a shortest distance from the point 1114 to the boundary of the vector-based outline.

As shown, the stroke extraction system 106 uses a straightening transition on the branch 1112. In particular, the stroke extraction system 106 extends the branch 1112 using a straightening transition. For example, the stroke extraction system 106 generates a straight spine from the point 1114 on the branch 1112 using a constant width profile based on r₁₁₁₄. profile. As shown, the stroke extraction system 106 extends the branch 1112 to the vector-based outline to generate the branch 1140.

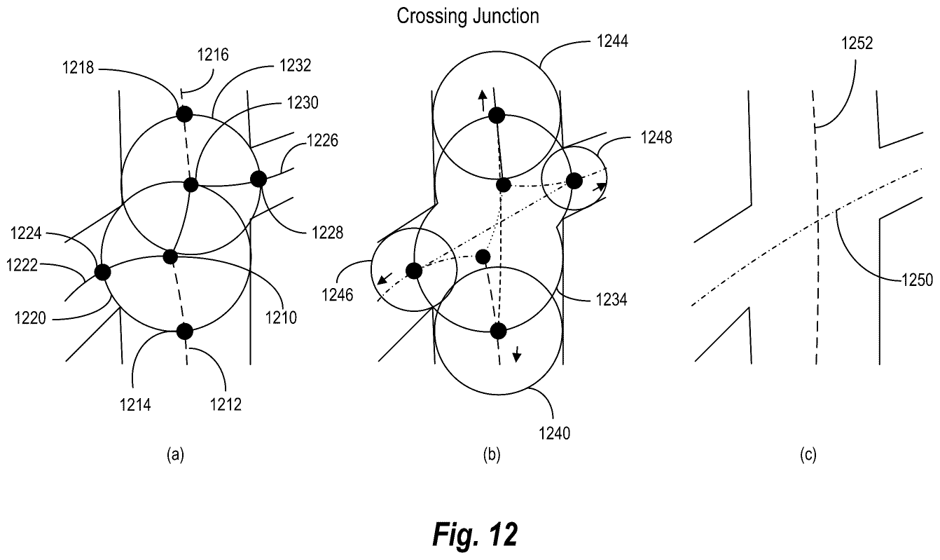

FIG. 12 illustrates the stroke extraction system 106 performing a transition for a crossing junction where two or more fork disks overlap in accordance with one or more embodiments. In the case where the stroke extraction system 106 determines there are two or more overlapping fork disks, the stroke extraction system 106 considers the overlapping fork disks as a union of distorted regions. For example, the stroke extraction system 106 determines a maximal disk 1220 centered on the vertex 1210 overlapping the maximal disk 1232 centered on the vertex 1230. As a result, the stroke extraction system 106 determines a fork union 1234 which includes the area of the maximal disk 1220 and the area of the maximal disk 1232.

In addition, the stroke extraction system 106 determines points where branches intersect the fork union 1234. For example, the stroke extraction system 106 determines a point 1214 on the branch 1212 outside where the branch 1212 intersects with the fork union 1234. Similarly, the stroke extraction system 106 determines a point 1218 on the branch 1216 outside where the branch 1216 intersects with the fork union 1234. Similarly, the stroke extraction system 106 determines a point 1224 on the branch 1222 outside where the branch 1222 intersects with the fork union 1234. Similarly, the stroke extraction system 106 determines a point 1228 on the branch 1226 outside where the branch 1226 intersects with the fork union 1234. As shown, the point 1214, the point 1218, the point 1224, and the point 1228 are points just outside the fork union 1234. In some embodiments, the stroke extraction system 106 determines the point 1214 as the point where the branch 1212 intersects with the fork union 1234, the point 1218 as the point where the branch 1216 intersects with the fork union 1234, the point 1224 as the point where the branch 1222 intersects with the fork union 1234, and the point 1228 as the point where the branch 1226 intersects with the fork union 1234.

The stroke extraction system 106 determines candidate pairs of branches by selecting pairs of branches that make an angle of nearly 180 degrees (e.g., between approximately 170-190 degrees). The stroke extraction system 106 merges candidate pairs of branches which are closest to 180 degrees apart in descending order of the angles between the candidate pairs. To merge the candidate pairs, the stroke extraction system 106 adjusts the pairs using a smoothing transition based on the tangents of the branches outside the fork union 1234 as parameters for a clothoid and the radii corresponding to the first maximal disks outside the fork union 1234.

To illustrate, as shown in the stroke extraction system 106 compares the tangents of the branches outside the fork union 1234 (e.g., the tangents of the branches at the position immediately outside the fork union 1234). For example, the stroke extraction system 106 compares the tangents of the branches at the point 1214, the point 1218, the point 1224, and the point 1228 to determine the angles formed by each pair of tangents (e.g., 6 possible pairs/angles). As shown, the tangent t₁₂₁₄ of the branch 1212 at point 1214 and the tangent t₁₂₁₈ of the branch 1216 at point 1218 make an angle θ₁ of nearly 180 degrees. As also shown, the tangent t₁₂₂₄ of the branch 1222 at point 1224 and the tangent t₁₂₂₈ of the branch 1226 at point 1228 make an angle θ₂ of nearly 180 degrees. Based on comparing the angle θ, and the angle θ₂ to determine the angle θ₁ is closer to 180 degrees, the stroke extraction system 106 selects the branch 1212 and the branch 1216 as the first pair to be merged using a smoothing transition. In addition, based on the angle θ₂ being the next closest to 180 degrees, the stroke extraction system selects the branch 1222 and the branch 1226 and the other pair to be merged using a smoothing transition.

As shown in FIG. 12, the stroke extraction system 106 adjusts the branch 1212 and the branch 1216 using a smoothing transition within the fork union 1234 based on the angle between the tangent t₁₂₁₄ and the tangent t₁₂₁₈. For example, to merge the branch 1212 and the branch 1216 using a smoothing transition, the stroke extraction system 106 utilizes the tangents t₁₂₁₄ and t₁₂₁₈ outside the fork union 1234 utilizing the associated radii r₁₂₁₄ and r₁₂₁₈. To elaborate, the stroke extraction system 106 determines a maximal disk 1240 for the point 1214 with a radius r₁₂₁₄ corresponding to a shortest distance from the point 1214 to the boundary of the vector-based outline. As also shown, the stroke extraction system 106 determines a maximal disk 1244 for the point 1218 with a radius r₁₂₁₈ corresponding to a shortest distance from the point 1218 to the boundary of the vector-based outline.

In addition, as described above, the stroke extraction system 106 utilizes a smoothing transition to generate a spine by sampling points along a clothoid curve, wherein the clothoid curve comprises a curvature change adjusted to match the tangent t₁₂₁₄ and the tangent t₁₂₁₈. For example, the stroke extraction system 106 utilizes a clothoid curve which connects the point 1214 and the point 1218 with disk radii that interpolate linearly between the initial and final radii r₁₂₁₄ and r₁₂₁₈. As described, the stroke extraction system 106 determines, based on the radii r₁₂₁₄ and r₁₂₁₈ and the interpolated disk radii, a stroke width along the branch between the point 1214 and the point 1218. As shown, the stroke extraction system 106 generates the composite branch 1252 based on the smoothing transition.

As also shown in FIG. 12, the stroke extraction system 106 adjusts the branch 1222 and the branch 1226 using a smoothing transition within the fork union 1234 based on the angle between the tangent t₁₂₂₄ and the tangent t₁₂₂₈. For example, to merge the branch 1222 and the branch 1226 using a smoothing transition, the stroke extraction system 106 utilizes the tangents t₁₂₂₄ and t₁₂₂₈ outside the fork union 1234 utilizing the associated radii r₁₂₂₄ and r₁₂₂₈. To elaborate, the stroke extraction system 106 determines a maximal disk 1246 for the point 1224 with a radius r₁₂₂₄ corresponding to a shortest distance from the point 1228 to the boundary of the vector-based outline. As also shown, the stroke extraction system 106 determines a maximal disk 1248 for the point 1228 with a radius r₁₂₂₈ corresponding to a shortest distance from the point 1228 to the boundary of the vector-based outline.

In addition, as described above, the stroke extraction system 106 utilizes a smoothing transition to generate a spine by sampling points along a clothoid, wherein the clothoid curve comprises a curvature change adjusted to match the tangent t₁₂₂₄ and the tangent t₁₂₂₈. For example, the stroke extraction system 106 utilizes a clothoid curve which connects the point 1224 and the point 1228 with disk radii that interpolate linearly between the initial and final radii r₁₂₂₄ and r₁₂₂₈. As described, the stroke extraction system 106 determines, based on the radii r₁₂₂₄ and r₁₂₂₈ and the interpolated disk radii, a stroke width along the branch between the point 1224 and the point 1228. As shown, the stroke extraction system 106 generates the composite branch 1250 based on the smoothing transition.

Notably, in some embodiments, the stroke extraction system 106 performs transitions for a crossing junction where one or less of the candidate pairs of branches make an angle of nearly 180 degrees. Additionally, in some embodiments, the stroke extraction system 106 performs transitions for a crossing junction where more than two of the candidate pairs of branches make an angle of nearly 180 degrees. Furthermore, the stroke extraction system 106 performs transitions for a crossing junction where more than 4 branches connect to the associated forks (e.g., 5, 6, or more branches). In such cases, in some embodiments, the stroke extraction system 106 merges candidate pairs of branches which are closest to 180 degrees apart in descending order of the angles between the candidate pairs until each branch has been the subject of a transition with another branch. To merge the candidate pairs, the stroke extraction system 106 adjusts the pairs as described in relation to FIG. 12 using a smoothing transition based on the tangents of the branches outside a fork union as parameters for a clothoid and the radii corresponding to the first maximal disks outside the fork union.

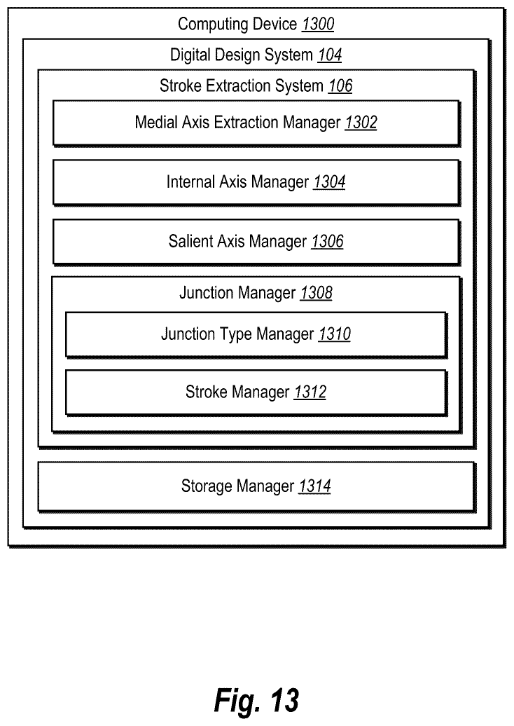

Turning now to FIG. 13, additional detail will now be provided regarding various components and capabilities of the stroke extraction system 106. In particular, FIG. 13 illustrates the stroke extraction system 106 implemented by the computing device 1300 (e.g., the server device(s) 102 and/or one of the client device(s) 108 discussed above with reference to FIG. 1). Additionally, the stroke extraction system 106 is also part of the digital design system 104. As shown in FIG. 13, the stroke extraction system 106 includes, but is not limited to, a medial axis extraction manager 1302, an internal axis manager 1304, a salient axis manager 1306, a junction manager 1308, and a storage manager 1314.

As just mentioned, and as illustrated in FIG. 13, the stroke extraction system 106 includes the medial axis extraction manager 1302. In one or more embodiments, the medial axis extraction manager 1302 manages the generation of medial axes from vector-based outline shapes. The medial axis extraction manager 1302 utilizes Voronoi diagrams and Delaunay triangulation to perform content analysis to identify and extract a medial axis from a vector-based outline shape. In some cases, the medial axis extraction manager 1302 uses chord residual regularization to discard spurious edges when determining the edges of the medial axis that capture the topological properties of the vector-based shape. For example, the medial axis extraction manager 1302 determines an internal medial axis and an external medial axis for the vector-based outline shape.

As shown in FIG. 13, the stroke extraction system 106 includes the internal axis manager 1304. The internal axis manager 1304 determines or isolates the internal medial axis by removing branches from the medial axis that are located outside of the vector-based outline. In particular, the internal axis manager 1304 utilizes chord residual regularization to discard small spurious medial axis branches generated during the Voronoi approximation. For example, the internal axis manager 1304 discards medial axis branches associated with the discretization of the vector-based outline.

As further shown in FIG. 13, the stroke extraction system 106 includes the salient axis manager 1306. In particular, the stroke extraction system 106 utilizes the salient axis manager 1306 to remove non-salient branches while retaining the salient branches of the medial axis. For example, the stroke extraction system 106 utilizes the salient axis manager 1306 to differentiate between medial axis branches that represent the main part of a stroke and medial axis branches that arise from the end of a path or a corner.

As further shown in FIG. 13, the stroke extraction system 106 includes the junction manager 1308. In particular, the stroke extraction system 106 utilizes the junction manager 1308 to modify the transitions of the medial axis at vertices to refine distorted transitions or merge branches. In particular, in certain embodiments, the junction manager 1308 to identify and process the forks to determine the intrinsic direction of each branch and how to merge and/or refine the branches. In some cases, the stroke extraction system 106 utilizes the junction manager 1308 to replace portions of one or more branches with a segment that smoothly interpolates between an initial and final pair of points corresponding to an intersection of the fork disk with the branches.

Furthermore, in some cases, the junction manager 1308 utilizes the junction type manager 1310 to determine the type of transition based on the type of junction. In some embodiments, the stroke extraction system 106 utilizes the junction type manager 1310 to determine junction types including T-junctions, Y-junctions, L-junctions, crossing junctions, and terminal junctions. For example, the stroke extraction system 106 utilizes the junction type manager 1310 to replace stroke ends using straight transitions and T-like junctions using smoothing transitions and/or straight transitions. When using a straight transition, the stroke extraction system 106 utilizes the junction type manager 1310 to connect the initial and final centers with a straight spine.

Furthermore, in some cases, the junction manager 1308 utilizes the stroke manager 1312 to transform the medial axis branches into a stroke graph with vertices, stroke spines, and stroke widths. In some embodiments, the stroke extraction system 106 utilizes the stroke manager 1312 to associate a vertex in the stroke graph with each branch of the medial axis. For example, the stroke extraction system 106 utilizes the stroke manager 1312 to associate distinct paths in the medial axis (branch) with a corresponding node or point in the stroke graph. In some cases, the stroke extraction system 106 utilizes the stroke manager 1312 to determine stroke graph vertices based on path centers of the medial axis. In some embodiments, the stroke manager 1312 utilizes vertices in the stroke graph as the points where information about the medial axis is stored and processed.

Additionally, as shown, the stroke extraction system 106 includes the storage manager 1314. In particular, the storage manager 1314 (implemented by one or more memory devices) stores the digital design documents, including the raster images. The storage manager 1314 facilitates the use of the digital design documents by the stroke extraction system 106.

Each of the components 1302-1314 of the stroke extraction system 106 includes software, hardware, or both. For example, the components 1302-1314 include one or more instructions stored on a computer-readable storage medium and executable by processors of one or more computing devices, such as a client device or server device. When executed by the one or more processors, the computer-executable instructions of the stroke extraction system 106 causes the computing device(s) to perform the methods described herein. Alternatively, the components 1302-1314 include hardware, such as a special-purpose processing device to perform a certain function or group of functions. Alternatively, the components 1302-1314 of the stroke extraction system 106 include a combination of computer-executable instructions and hardware.

Furthermore, the components 1302-1314 of the stroke extraction system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1302-1314 of the stroke extraction system 106 are implemented as a stand-alone application, such as a desktop or mobile application. Furthermore, in some embodiments, the components 1302-1314 of the stroke extraction system 106 are implemented as one or more web-based applications hosted on a remote server. Alternatively, or additionally, the components 1302-1314 of the stroke extraction system 106 are implemented in a suite of mobile device applications or “apps.” For example, in one or more embodiments, the stroke extraction system 106 comprises or operates in connection with digital software applications such as: ADOBE® PHOTOSHOP®, ADOBE® PHOTOSHOP® ELEMENTS, ADOBE® ILLUSTRATOR®, ADOBE® TYPEKIT, ADOBE® STOCK®, ADOBE® SPARK POST, ADOBE® INDESIGN®, and ADOBE® ACROBAT® MOBILE, ADOBE® SPARK PAGE, ADOBE® FRESCO. The foregoing are either registered trademarks or trademarks of Adobe Inc. in the United States and/or other countries.

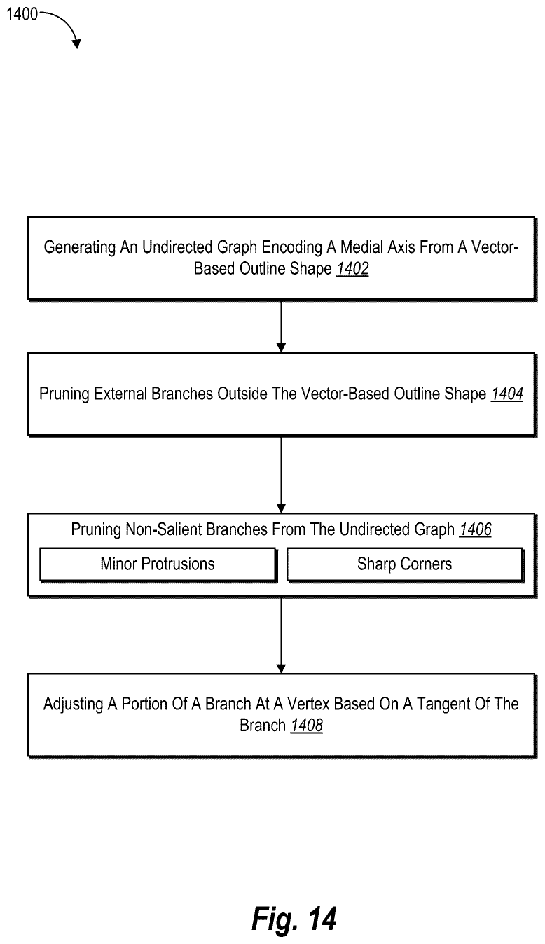

FIGS. 1-13, the corresponding text, and the examples provide a number of different methods, systems, devices, and non-transitory computer-readable media of the stroke extraction system 106. In addition to the foregoing, one or more embodiments are also described in terms of flowcharts comprising acts for accomplishing a particular result, as shown in FIG. 14. In some embodiments, the acts shown in FIG. 14 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 14. In some embodiments, a system is configured to perform the acts of FIG. 14. Alternatively, the acts of FIG. 14 are performed as part of a computer-implemented method.

FIG. 14 illustrates a flowchart of a series of acts 1400 for modifying a digital document with a stroke extraction system 106 in accordance with one or more embodiments. While FIG. 14 illustrates acts according to one embodiment, alternative embodiments omit, add to, reorder, and/or modify any acts shown in FIG. 14.

FIG. 14 illustrates an example series of acts 1400 for utilizing a stroke extraction system 106 to convert a vector-based outline shape to a stroke-based design. In particular, in certain embodiments, the series of acts 1400 includes an act 1402 of generating an undirected graph encoding a medial axis from a vector-based outline shape. Specifically, in one or more embodiments, the act 1402 includes generating, from the vector-based outline shape, an undirected graph encoding a medial axis utilizing branches corresponding to continuous sequences of edges connected by vertices. In particular, in certain embodiments, the series of acts 1400 includes an act 1404 of pruning external branches outside the vector-based outline shape. In particular, in one or more embodiments, the act 1404 includes pruning, from the branches, external branches positioned outside a boundary of the vector-based outline shape. As illustrated, in some embodiments, the series of acts 1400 also includes an act 1406 of pruning non-salient branches from the undirected graph, including pruning branches corresponding to minor protrusions and sharp corners from the undirected graph. In particular, in one or more embodiments, the act 1406 includes pruning, from the branches, non-salient branches by removing one or more branches corresponding to minor protrusions or sharp corners of the vector-based outline shape under a saliency threshold. As illustrated, in some embodiments, the series of acts 1400 also includes an act 1408 of adjusting a portion of a branch based on a tangent of the branch. In particular, in one or more embodiments, the act 1408 includes adjusting, based on a tangent of a branch at a fork disk centered on a vertex in the undirected graph, a portion of a branch at the vertex by performing a transition on the portion of the branch.

In addition (or in the alternative) to the acts described above, in certain embodiments, the stroke extraction system series of acts 1400 includes generating the undirected graph by defining a set of points corresponding to centers of maximal disks, wherein the maximal disks have more than one closest point on the boundary of the vector-based outline shape. In some embodiments, the series of acts 1400 also includes performing the transition as a smoothing transition by estimating, using a secant-based method, a rate of change of curvature along the portion of the branch.

Moreover, in one or more embodiments, the stroke extraction system 106 series of acts 1400 includes determining a fork disk as a maximal disk centered at the vertex. Further still, in some embodiments, the stroke extraction system 106 series of acts 1400 includes determining a first maximal disk with a first center located on the branch at an initial point outside the fork disk. Furthermore, in one or more embodiments, the stroke extraction system series of acts 1400 includes determining a second maximal disk with a second center located on an additional branch at an initial point outside the fork disk. Moreover, one or more embodiments, the series of acts 1400 includes performing the transition as a smoothing transition by interpolating a transition utilizing points along a clothoid curve to connect the first center and the second center.

Further still, in one or more embodiments, the series of acts 1400 includes determining a first radius corresponding to a shortest distance from the first center to a first boundary of the vector-based outline shape. Moreover, in one or more embodiments, the series of acts 1400 includes determining a second radius corresponding to a shortest distance from the second center to a second boundary of the vector-based outline shape. In certain embodiments, the series of acts 1400 further includes determining, based on the first radius and the second radius, a stroke width along the branch between the first center and the second center. Moreover, one or more embodiments, the series of acts 1400 includes determining a difference between a first tangent of the branch at the first center and a second tangent of the additional branch at the second center. Furthermore, in one or more embodiments, the series of acts 1400 includes adjusting the branch and the additional branch at the vertex based on an angle between the first tangent and the second tangent.

Moreover, in one or more embodiments, the series of acts 1400 includes determining a type of junction at the vertex by comparing a first tangent of the branch at the fork disk on the undirected graph and a second tangent of an additional branch at the fork disk on the undirected graph. In one or more embodiments, the series of acts 1400 includes adjusting, based on the type of junction, a transition between the branch and the additional branch on the undirected graph utilizing either a straight transition or a smoothing transition. Further still, in one or more embodiments, the series of acts 1400 includes determining stroke graph vertices based on path centers of the medial axis. Moreover, in one or more embodiments, the series of acts 1400 includes determining stroke widths based on radii of medial axis maximal disks.

In one or more embodiments, the series of acts 1400 further includes generating, from the vector-based outline shape, an undirected graph encoding a medial axis corresponding to features of the vector-based outline shape, wherein the undirected graph comprises a first branch and a second branch connected at a vertex. In addition, in one or more embodiments, the series of acts 1400 includes determining a fork disk, wherein the fork disk is a maximal disk with a center corresponding to the vertex and a radius corresponding to the shortest distance to a boundary of the vector-based outline shape. Furthermore, in one or more embodiments, the series of acts 1400 includes adjusting, utilizing a smoothing transition, a transition segment between the first branch and the second branch on the undirected graph based on a comparison of a first tangent of the first branch at an intersection between the first branch and the fork disk and a second tangent of the second branch at an intersection of the second branch and the fork disk.

In addition, in one or more embodiments, the series of acts 1400 includes, wherein the undirected graph comprises a third branch connected at the vertex, determining an angle between the first tangent and the second tangent satisfies a smoothing criteria for a smoothing transition. Moreover, in one or more embodiments, the series of acts 1400 includes adjusting, using a smoothing transition, the transition segment based on the angle satisfying the smoothing criteria for a smoothing transition. In one or more embodiments, the series of acts 1400 includes adjusting, using a straight transition, the third branch to intersect with the transition segment.

Furthermore, in one or more embodiments, the series of acts 1400 includes, wherein the undirected graph comprises a third branch connected at the vertex, determining a third tangent of the third branch at an intersection of the third branch and the fork disk. In some embodiments, the series of acts 1400 also includes determining a first angle between the first tangent and the second tangent, a second angle between the first tangent and the third tangent, and a third angle between the second tangent and the third tangent do not satisfy a smoothing criteria. Moreover, in one or more embodiments, the stroke extraction system 106 series of acts 1400 includes determining the first angle is greater than the third angle. Further still, in some embodiments, the stroke extraction system 106 series of acts 1400 includes determining the second angle is greater than the third angle. Furthermore, in one or more embodiments, the stroke extraction system series of acts 1400 includes adjusting, utilizing an additional smoothing transition, an additional transition segment between the first branch and the third branch on the undirected graph.

Moreover, one or more embodiments, the series of acts 1400 includes, wherein the undirected graph comprises a third branch connected at the vertex, pruning, from the undirected graph, the third branch based on a saliency threshold. Further still, in one or more embodiments, the series of acts 1400 includes adjusting, the first branch and the second branch until they intersect utilizing a first straight transition on the first branch and a second straight transition on the second branch.

Moreover, in one or more embodiments, the series of acts 1400 includes, wherein the undirected graph comprises a third branch connected at the vertex, determining an additional fork disk that overlaps the fork disk, wherein the additional fork disk is a maximal disk with a center corresponding to an additional vertex on the medial axis, and the undirected graph comprises a fourth branch connected at the additional vertex. In certain embodiments, the series of acts 1400 further includes determining a fork union comprising a union of an area of the fork disk and an area of the additional fork disk. Moreover, one or more embodiments, the series of acts 1400 includes determining a first union tangent of the first branch at an intersection between the first branch and the fork union, a second union tangent of the second branch at an intersection of the second branch and the fork union, a third union tangent of the third branch at an intersection of the third branch and the fork union, a fourth union tangent of the fourth branch at an intersection of the fourth branch and the fork union. Furthermore, in one or more embodiments, the series of acts 1400 includes adjusting, utilizing a smoothing transition, an additional transition segment between the third branch and the fourth branch on the undirected graph based on a comparison of the first union tangent, the second union tangent, the third union tangent, and the fourth union tangent.

Moreover, in one or more embodiments, the series of acts 1400 includes performing the smoothing transition by generating a spine from points sampled along a clothoid curve, wherein the clothoid curve comprises a curvature change adjusted to match the first tangent and the second tangent. In one or more embodiments, the series of acts 1400 includes determining a boundary segment on the vector-based outline shape associated with a target branch such that endpoints of the boundary segment correspond to two intersection points between the vector-based outline shape and a maximal disk centered at the vertex. Further still, in one or more embodiments, the series of acts 1400 includes generating a saliency measure based on comparing a width of the vector-based outline shape between the two intersection points to a length of the boundary segment. Moreover, in one or more embodiments, the series of acts 1400 includes pruning the target branch from the undirected graph.

Moreover, one or more embodiments, the series of acts 1400 includes generating, from the vector-based outline shape, an undirected graph encoding a medial axis corresponding to features of the vector-based outline shape, wherein the undirected graph comprises a first branch, a second branch, and a third branch connected at a vertex associated with a fork disk comprising a maximal disk centered at the vertex. Further still, in one or more embodiments, the series of acts 1400 includes pruning, from the undirected graph, the third branch connected at the vertex based on a saliency threshold. Moreover, in one or more embodiments, the series of acts 1400 includes determining a type of junction at the vertex by comparing a first tangent of the first branch outside the fork disk and a second tangent of the second branch outside the fork disk. In certain embodiments, the series of acts 1400 further includes adjusting, based on the type of junction, a transition between the first branch and the second branch on the undirected graph comprising either a straight transition or a smoothing transition.

Moreover, one or more embodiments, the series of acts 1400 includes generating the medial axis by generating, utilizing a Voronoi diagram, edges comprising sets of points equidistant from the vector-based outline shape. Furthermore, in one or more embodiments, the series of acts 1400 includes comprising determining the type of junction at the vertex by determining a saliency of the first branch, the second branch, and the third branch.

Moreover, in one or more embodiments, the series of acts 1400 includes determining a fork union comprising a union of an area of the fork disk and an area of an additional fork disk centered on an additional vertex, wherein the third branch and a fourth branch connect to the additional vertex. In one or more embodiments, the series of acts 1400 includes comparing a first union tangent of the first branch outside the fork union, a second union tangent of the second branch outside the fork union, comparing a third union tangent of the third branch outside the fork union, and a fourth union tangent of the fourth branch outside the fork union. Further still, in one or more embodiments, the series of acts 1400 includes adjusting, utilizing a smoothing transition, an additional transition between the third branch and the fourth branch on the undirected graph based on a comparison of the first union tangent, the second union tangent, the third union tangent, and the fourth union tangent.

In one or more embodiments, the series of acts 1400 includes merging the first branch and the second branch into a composite branch of the undirected graph based on the transition. Further still, in one or more embodiments, the series of acts 1400 includes converting branches of the undirected graph into strokes utilizing a stroke graph.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., server device(s) 102, client device(s) 108, and computing device 1500). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 9, the components illustrated in FIG. 9 are not intended to be limiting. Additional or alternative components may be used in other embodiments. Furthermore, in certain embodiments, the computing device 1500 includes fewer components than those shown in FIG. 9. Components of the computing device 1500 shown in FIG. 9 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
converting a vector-based outline shape to a stroke-based design by performing operations comprising:
generating, from the vector-based outline shape, an undirected graph encoding a medial axis utilizing branches corresponding to continuous sequences of edges connected by vertices;
pruning, from the branches, external branches positioned outside a boundary of the vector-based outline shape;
pruning, from the branches, non-salient branches by removing one or more branches corresponding to minor protrusions or sharp corners of the vector-based outline shape under a saliency threshold; and
adjusting, based on a tangent of a branch at a fork disk centered on a vertex in the undirected graph, a portion of a branch at the vertex by performing a transition on the portion of the branch.

2. The computer-implemented method of claim 1, further comprising generating the undirected graph by defining a set of points corresponding to centers of maximal disks, wherein the maximal disks have more than one closest point on the boundary of the vector-based outline shape.

3. The computer-implemented method of claim 1, further comprising performing the transition as a smoothing transition by estimating, using a secant-based method, a rate of change of curvature along the portion of the branch.

4. The computer-implemented method of claim 1, further comprising:
determining a fork disk as a maximal disk centered at the vertex;
determining a first maximal disk with a first center located on the branch at an initial point outside the fork disk;
determining a second maximal disk with a second center located on an additional branch at an initial point outside the fork disk; and
performing the transition as a smoothing transition by interpolating a transition utilizing points along a clothoid curve to connect the first center and the second center.

5. The computer-implemented method of claim 4, further comprising:
determining a first radius corresponding to a shortest distance from the first center to a first boundary of the vector-based outline shape;
determining a second radius corresponding to a shortest distance from the second center to a second boundary of the vector-based outline shape; and
determining, based on the first radius and the second radius, a stroke width along the branch between the first center and the second center.

6. The computer-implemented method of claim 4, further comprising:
determining a difference between a first tangent of the branch at the first center and a second tangent of the additional branch at the second center; and
adjusting the branch and the additional branch at the vertex based on an angle between the first tangent and the second tangent.

7. The computer-implemented method of claim 1, further comprising:
determining a type of junction at the vertex by comparing a first tangent of the branch at the fork disk on the undirected graph and a second tangent of an additional branch at the fork disk on the undirected graph; and
adjusting, based on the type of junction, a transition between the branch and the additional branch on the undirected graph utilizing either a straight transition or a smoothing transition.

8. The computer-implemented method of claim 1, further comprising converting the branches of the undirected graph into strokes utilizing a stroke graph by:
determining stroke graph vertices based on path centers of the medial axis; and
determining stroke widths based on radii of medial axis maximal disks.

9. A system comprising:
one or more memory devices; and
one or more processors coupled to the one or more memory devices, the one or more processors configured to convert a vector-based outline shape to a stroke-based design by causing the system to:
generate, from the vector-based outline shape, an undirected graph encoding a medial axis corresponding to features of the vector-based outline shape, wherein the undirected graph comprises a first branch and a second branch connected at a vertex;
determine a fork disk, wherein the fork disk is a maximal disk with a center corresponding to the vertex and a radius corresponding to a shortest distance to a boundary of the vector-based outline shape; and
adjust, utilizing a smoothing transition, a transition segment between the first branch and the second branch on the undirected graph based on a comparison of a first tangent of the first branch at an intersection between the first branch and the fork disk and a second tangent of the second branch at an intersection of the second branch and the fork disk.

10. The system of claim 9, wherein the undirected graph comprises a third branch connected at the vertex and the one or more processors are further configured to:
determine an angle between the first tangent and the second tangent satisfies a smoothing criteria for a smoothing transition;
adjust, using a smoothing transition, the transition segment based on the angle satisfying the smoothing criteria for a smoothing transition; and
adjust, using a straight transition, the third branch to intersect with the transition segment.

11. The system of claim 9, wherein the undirected graph comprises a third branch connected at the vertex and the one or more processors are further configured to:
determine a third tangent of the third branch at an intersection of the third branch and the fork disk;
determine a first angle between the first tangent and the second tangent, a second angle between the first tangent and the third tangent, and a third angle between the second tangent and the third tangent do not satisfy a smoothing criteria;
determine the first angle is greater than the third angle;
determine the second angle is greater than the third angle; and
adjust, utilizing an additional smoothing transition, an additional transition segment between the first branch and the third branch on the undirected graph.

12. The system of claim 9, wherein the undirected graph comprises a third branch connected at the vertex and the one or more processors are further configured to:
prune, from the undirected graph, the third branch based on a saliency threshold; and
adjust, the first branch and the second branch until they intersect utilizing a first straight transition on the first branch and a second straight transition on the second branch.

13. The system of claim 9, wherein the undirected graph comprises a third branch connected at the vertex and the one or more processors are further configured to:
determine an additional fork disk that overlaps the fork disk, wherein:
the additional fork disk is a maximal disk with a center corresponding to an additional vertex on the medial axis; and
the undirected graph comprises a fourth branch connected at the additional vertex;
determine a fork union comprising a union of an area of the fork disk and an area of the additional fork disk;
determine a first union tangent of the first branch at an intersection between the first branch and the fork union, a second union tangent of the second branch at an intersection of the second branch and the fork union, a third union tangent of the third branch at an intersection of the third branch and the fork union, a fourth union tangent of the fourth branch at an intersection of the fourth branch and the fork union; and
adjust, utilizing a smoothing transition, an additional transition segment between the third branch and the fourth branch on the undirected graph based on a comparison of the first union tangent, the second union tangent, the third union tangent, and the fourth union tangent.

14. The system of claim 9, wherein the one or more processors are further configured to perform the smoothing transition by generating a spine from points sampled along a clothoid curve, wherein the clothoid curve comprises a curvature change adjusted to match the first tangent and the second tangent.

15. The system of claim 9, wherein the one or more processors are further configured to:
determine a boundary segment on the vector-based outline shape associated with a target branch such that endpoints of the boundary segment correspond to two intersection points between the vector-based outline shape and a maximal disk centered at the vertex;
generate a saliency measure based on comparing a width of the vector-based outline shape between the two intersection points to a length of the boundary segment; and
prune the target branch from the undirected graph.

16. A non-transitory computer readable medium storing executable instructions which, when executed by a processing device, cause the processing device to perform operations to convert a vector-based outline shape to a stroke-based design, the operations comprising:
generating, from the vector-based outline shape, an undirected graph encoding a medial axis corresponding to features of the vector-based outline shape, wherein the undirected graph comprises a first branch, a second branch, and a third branch connected at a vertex associated with a fork disk comprising a maximal disk centered at the vertex;
pruning, from the undirected graph, the third branch connected at the vertex based on a saliency threshold;
determining a type of junction at the vertex by comparing a first tangent of the first branch outside the fork disk and a second tangent of the second branch outside the fork disk; and
adjusting, based on the type of junction, a transition between the first branch and the second branch on the undirected graph comprising either a straight transition or a smoothing transition.

17. The non-transitory computer readable medium of claim 16, further comprising generating the medial axis by generating, utilizing a Voronoi diagram, edges comprising sets of points equidistant from the vector-based outline shape.

18. The non-transitory computer readable medium of claim 16, further comprising determining the type of junction at the vertex by determining a saliency of the first branch, the second branch, and the third branch.

19. The non-transitory computer readable medium of claim 16, further comprising:
determining a fork union comprising a union of an area of the fork disk and an area of an additional fork disk centered on an additional vertex, wherein the third branch and a fourth branch connect to the additional vertex;
comparing a first union tangent of the first branch outside the fork union, a second union tangent of the second branch outside the fork union, comparing a third union tangent of the third branch outside the fork union, and a fourth union tangent of the fourth branch outside the fork union; and
adjusting, utilizing a smoothing transition, an additional transition between the third branch and the fourth branch on the undirected graph based on a comparison of the first union tangent, the second union tangent, the third union tangent, and the fourth union tangent.

20. The non-transitory computer readable medium of claim 16, further comprising:
merging the first branch and the second branch into a composite branch of the undirected graph based on the transition; and
converting branches of the undirected graph into strokes utilizing a stroke graph.
